(19) United States
(12) Patent Application Publication
(10) Pub. No.: US 2005/0211617 A1
(43) Pub. Date: Sep. 29, 2005

(54) High throughput flash purification stand and cartridge

(75) Inventors: Robert O. Held, State College, PA (US); Carl Douglas Cox, Hollidaysburg, PA (US)

Correspondence Address: SENNIGER POWERS LEAVITT AND ROEDEL, ONE METROPOLITAN SQUARE, 16TH FLOOR, ST LOUIS, MO, 63102, US

(73) Assignee: Sigma-Aldrich Co., St. Louis, MO (US)

(21) Appl. No.: 11/072,614

(22) Filed: Mar. 4, 2005

Related U.S. Application Data
(63) Continuation-in-part of application No. 10/792,988, filed on Mar. 4, 2004.
Application No. 10/792,988 is a continuation-in-part of application No. 10/621,813, filed on Jul. 17, 2003.

(51) Int. Cl. B01D 15/08

(52) U.S. Cl. 210/198.2; 422/70; 73/61.58; 73/61.52

(57) ABSTRACT

A chromatography cartridge for use in a chromatography stand has a hollow body for containing chromatography media and an end cap adapted to fit in an open end of the hollow body for closing the end of the hollow body. The end cap has an external axial surface at least partially received in the hollow body and an outer face. At least one barb extends from the external axial surface of the end cap. The at least one barb is shaped and arranged to contact an interior surface of the hollow body. At least one sealing protrusion extends from the external axial surface of the end cap. The at least one sealing protrusion is shaped and arranged for use in forming a fluid-tight connection between the end cap and the hollow body.

### CROSS-REFERENCE TO RELATED APPLICATION

This application is a Continuation-in-Part of U.S. patent application Ser. No. 10/792,988, filed Mar. 4, 2004, which is a Continuation-in-Part of U.S. patent application Ser. No. 10/621,813, filed Jul. 17, 2003, both of which are hereby incorporated herein by reference.

### BACKGROUND OF THE INVENTION

The present invention relates generally to liquid chromatography apparatus, and more particularly to a liquid chromatography stand and chromatography cartridges and methods of use in a high throughput flash purification system.

Liquid chromatography is well known in the art as a method for separating a complex mixture. Liquid chromatographic techniques employ separation of one or more components of a mixture from other components thereof by flow through a chromatographic column, followed by detection of the separated components with a flow-through detector. A mobile phase consisting of a carrier fluid (i.e., solvent) and a sample composition to be identified, analyzed, or purified is passed through the column containing a media (e.g., silica gel), called a stationary phase (i.e., sorbent). Different components of the sample pass through the column at different rates and are thereby separated from each other, leaving the column at different times.

Liquid chromatography is commonly performed with reusable columns or with disposable cartridges, both of which are usually cylindrical. The media bed is bounded axially by porous plates, or plates containing defined flow paths, through which the mobile phase will flow. The cartridges are typically mounted upright on a stand to facilitate flow through the cartridges and collection of the sample components. In traditional column chromatography a sample to be separated is placed on the top of the column containing the media and the rest of the column is then filled with a solvent (or mixture of solvents) which flows through media under the force of gravity. The various sample components to be separated travel through the column at different rates and are collected separately as they emerge from the bottom of the column. In traditional column chromatography, the rate at which the solvent percolates through the column is slow.

Traditional flash chromatography is a method similar to conventional column chromatography except that solvent flow is generated by applying air pressure to a solvent reservoir to speed up the separation of the sample. Reference may be made to U.S. Pat. No. 4,293,422 for additional background information relating to flash chromatography. High-Throughput Flash Purification (HTFP) is one type of flash chromatography that is typically used to purify a sample material by separating and removing unwanted components from the sample. In HTFP, a pump or other device is used to supply solvent at an elevated pressure to speed up the flow of solvent through the column, dramatically decreasing the time needed to separate and purify the sample. After a sample is purified by HTFP, the resulting component of interest may be used for testing or further synthesis and analysis such as by mass spectroscopy or other tools for molecular configuration analysis.

Typically, a sample to be purified by HTFP is injected into the solvent flow downstream of the pump and upstream of the cartridge. Alternatively, a sample may be pre-absorbed onto the cartridge media prior to assembly of the cartridge, and placed at the head of a pre-packed chromatography cartridge so that solvent will flow through the pre-absorbed media first and then carry the components of the sample through the column of separation media. These methods are time consuming and add extra steps to sample purification by HTFP.

Existing chromatography stands have fixed supports so that a chromatography cartridge can be held for connection to inlet and discharge tubing. In some chromatographic separations the chemical characteristics of a sample require an extended length of cartridge with a longer stationary bed or a larger diameter cartridge to accurately and efficiently perform the separation. Existing stands are not adjustable to allow variable length cartridges to be used in the same apparatus and do not allow variable diameter cartridges to be interchangeably used on the same stand. Also, existing stands and cartridges are not configured to allow rapid change out of the cartridge after the separation is complete.

### SUMMARY OF THE INVENTION

Among the several objects of this invention may be noted the provision of a chromatography stand which allows for quick installation and removal of a chromatography cartridge; the provision of such a stand which allows use with cartridges having different diameters and lengths; the provision of such a stand which allows for an extended length of separating media; and the provision of such a stand which allows for reliable fluid connections between the stand and the cartridge.

Further among the objects and features of the present invention may be noted the provision of a chromatography cartridge which is easy to mount on a chromatography stand; the provision of such a cartridge which allows plug-in connection to the stand; the provision of such a cartridge which allows quick and easy removal from the stand; the provision of such a cartridge which is easy to manufacture; the provision of such a cartridge which may be stacked with other cartridges; the provision of such a cartridge which allows for compression of the media bed; the provision of such a cartridge which facilitates sample loading; and the provision of such a cartridge which facilitates flushing of the purified sample.

Further among the several objects and features of the present invention may be noted the provision of a method for operating a chromatography column which allows longer separating beds; the provision of such a method which separates complex mixtures; the provision of such a method which allows bi-modal separations; the provision of such a method which provides for the removal of impurities from the sample prior to separation; and the provision of such a method that can easily incorporate the sample mixture into the column.

Further among the several objects and features of the present invention may be noted the provision of a method for loading a sample in a chromatography cartridge which is simplified and more convenient; the provision of such a method which eliminates operator exposure to the cartridge media; the provision of such a method which reduces impurities in the sample; and the provisions of such a method which allows for simultaneous loading of multiple cartridges.

In general, a chromatography cartridge for use in a chromatography stand comprises a hollow body for containing chromatography media and an end cap adapted to fit in an open end of the hollow body for closing the end of the hollow body. The end cap has an external axial surface at least partially received in the hollow body and an outer face. At least one barb extends from the external axial surface of the end cap. The at least one barb is shaped and arranged to contact an interior surface of the hollow body. At least one sealing protrusion extends from the external axial surface of the end cap. The at least one sealing protrusion is shaped and arranged for use in forming a fluid-tight connection between the end cap and the hollow body.

In yet another aspect of the invention, an end cap for use in a chromatography cartridge having a hollow body containing chromatography media comprises a body with an external axial surface adapted to be received in the hollow body. A flange projects radially outward from the body and is adapted to engage an end of the hollow body. A connector portion at an end of the end cap is used for connecting the cartridge to a chromatography stand. At least one barb projects from the external axial surface of the body for contact with an interior surface of the hollow body. At least one sealing protrusion projects from the external axial surface of the body for contact with the interior surface of the hollow body. The sealing protrusion is shaped and arranged to form a fluid-tight connection between the end cap and the hollow body.

Other objects and features will be in part apparent and in part pointed out hereinafter.

### BRIEF DESCRIPTION OF THE DRAWINGS

FIG. 1 is a front elevation of a chromatography stand and cartridge of the present invention, portions of the stand and cartridge being broken away to show details;

FIG. 1A is a cross-section taken along the plane including line 1A-1A of FIG. 1, portions of the stand being broken away to show details;

FIG. 2 is an enlarged fragment of FIG. 1 showing a bottom platen of the stand and portion of the cartridge;

FIG. 3 is an elevation of a chromatography cartridge of the present invention with parts broken away to show internal construction;

FIG. 4 is a plan view of the end cap showing a surface of the end cap which faces inwardly into the cartridge;

FIG. 5 is a cross-section of an end cap of the chromatography cartridge taken along the plane including the line 5-5 of FIG. 4;

FIG. 6 is a cross-section taken along the plane including line 6-6 of FIG. 1 through a base of the stand;

FIG. 7 is a fragmentary side elevation of the stand, with an exterior wall of the base removed to show an actuator mechanism of a bottom platen in a load position;

FIG. 7A is the side elevation of FIG. 7 showing the actuator mechanism in an idle position;

FIG. 7B is the side elevation of FIG. 7 showing the actuator mechanism in an operate position;

FIG. 8 is a perspective of a cam of the actuator mechanism;

FIG. 9 is a front elevation of the chromatography stand mounting stacked cartridges;

FIG. 9A is an enlarged, fragmentary portion of the stacked cartridges of FIG. 9;

FIG. 9B is a view similar to FIG. 9A but showing an alternate embodiment of a coupler connecting the stacked cartridges;

FIG. 10 is an exploded perspective of the stacked cartridges of FIG. 9;

FIG. 11 is a longitudinal section of a connector sleeve of the stacked cartridges;

FIG. 12 is a cross-section of a connector for the stacked cartridges;

FIG. 12A is a cross-section of a second embodiment of a connector;

FIG. 13 is a front elevation of the chromatography stand having another pair of stacked cartridges;

FIG. 14 is a elevation of a chromatography stand of the present invention connected to HTFP system;

FIG. 15 is a schematic of a cartridge loading station of the present invention;

FIG. 16A is a cross-section of a first embodiment of a flush connector of the present invention;

FIG. 16B is an end view of the flush connector of FIG. 16A;

FIG. 17A is a cross-section of a second embodiment of a flush connector of the present invention;

FIG. 17B is an end view of the flush connector of FIG. 17A;

FIG. 18 is an elevation of a second embodiment of a chromatography cartridge of the present invention with parts broken away to show internal construction;

FIG. 19 is a plan view of an end cap of the embodiment of FIG. 18 showing a surface of the end cap which faces inwardly into the cartridge;

FIG. 20 is a cross-section of the end cap of the chromatography cartridge taken along the plane including the line 20-20 of FIG. 19;

FIG. 20A is an enlarged portion of the end cap of FIG. 20;

FIG. 21 is an exploded perspective of the cartridge of FIG. 18;

FIG. 22 is cross-section of a third embodiment of a chromatography cartridge of the present invention;

FIG. 23 is a cross-section of the end cap of the chromatography cartridge of FIG. 22;

FIG. 24 is an enlarged, fragmentary portion of the end cap of FIG. 23; and

FIG. 25 is an enlarged, fragmentary portion of the end cap of FIG. 23.

Corresponding parts are designated by corresponding reference numbers throughout the drawings.

### DETAILED DESCRIPTION OF PREFERRED EMBODIMENTS

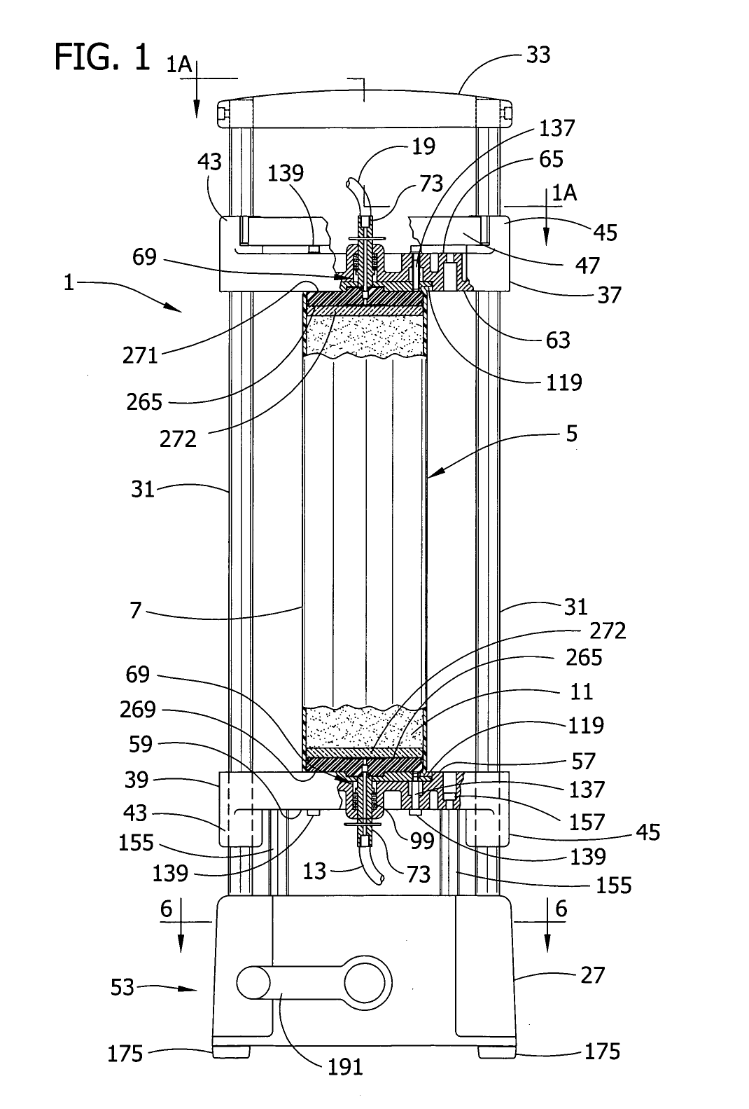

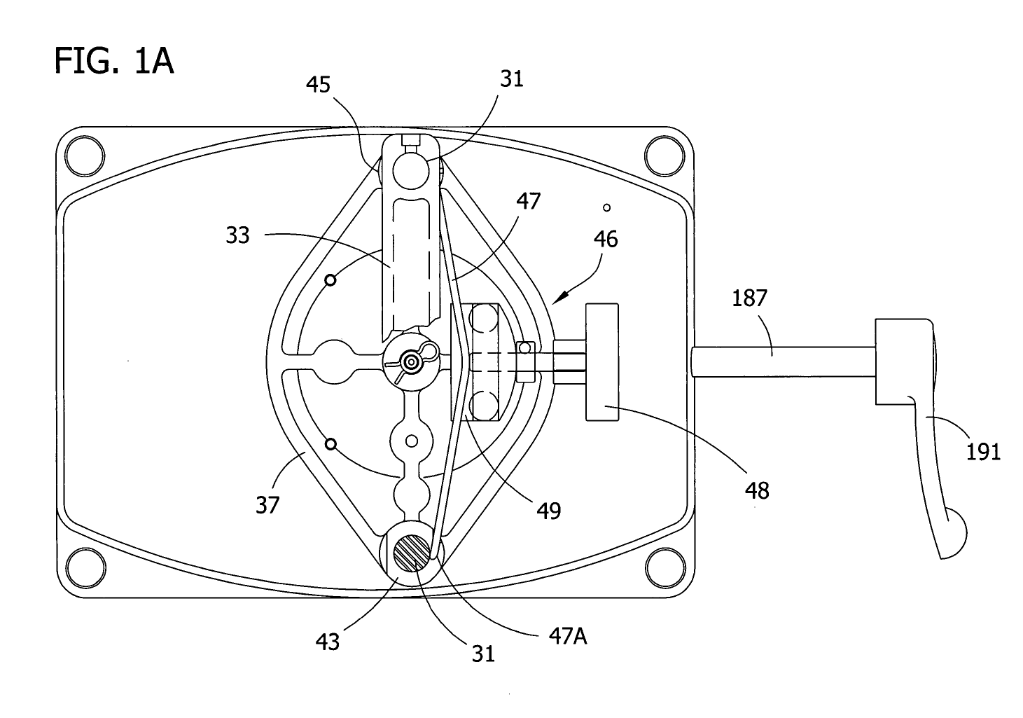

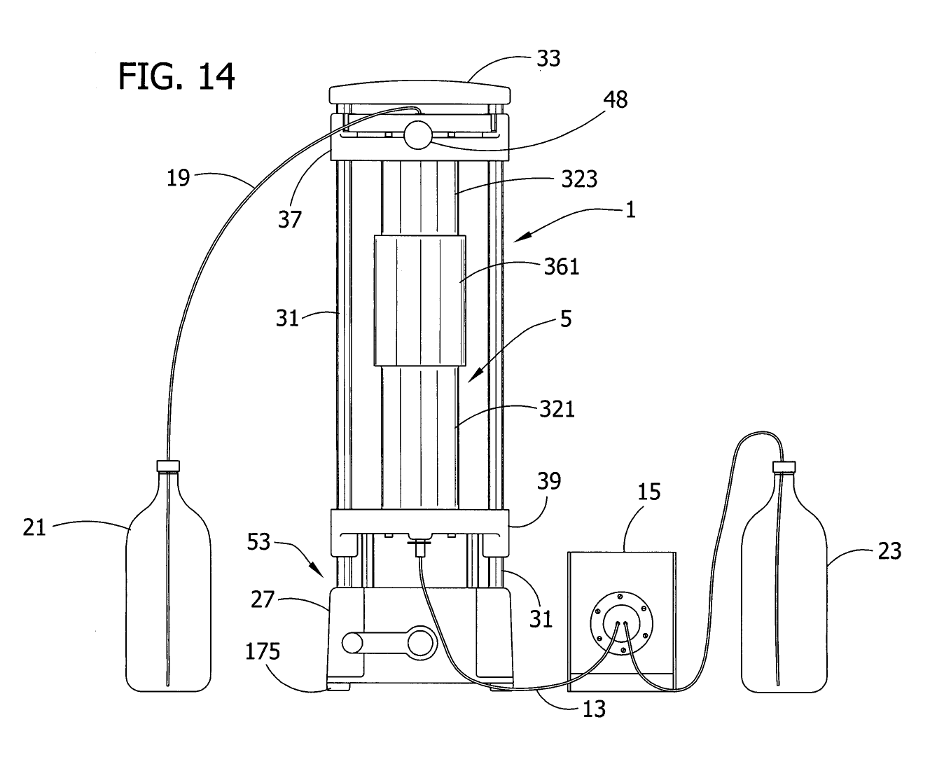

Referring now to the drawings, and more particularly to FIG. 1, one embodiment of a liquid chromatography stand of the present invention is designated in its entirety by the reference numeral 1. The stand can be used in a conventional High-Throughput Flash Purification (HTFP) system, generally designated 3 and shown in FIG. 14, to separate or purify a sample material. The stand 1 has a chromatography column, generally designated 5, which, in the embodiment of FIG. 1, comprises a single chromatography cartridge 7 containing a bed of chromatography media 11 that is in fluid connection with upstream tubing 13 connected to a pump 15 and downstream tubing 19 leading to a collection container 21. The pump 15 receives fluid from a supply container 23 and discharges solvent at a fluid pressure sufficient to convey the solvent through the cartridge 7. The collection container 21 receives the various sample components that flow through the bed of separating media 11 in the column 5 at different rates. As will be discussed below in more detail, the sample to be separated may be injected into the upstream tubing 13 between the pump 15 and the stand 1, may be pre-loaded onto the chromatography cartridge 7 prior to installation of the cartridge on the stand, or may be added to the solvent in the supply container 23 upstream of the pump 15.

As shown in FIG. 1, the stand 1 comprises a base 27, a frame mounted on the base comprising two rods 31 extending up from the base, and a head 33 mounted on the top of the rods. A first (i.e., upper or top) platen 37 and second (i.e., lower or bottom) platen 39 are moveably mounted on the rods 31 in generally opposed relation and are constructed for plug-in connection with opposite ends of the chromatographic cartridge 7. Each platen 37, 39 is formed with two sleeves 43, 45 at opposite sides of the platen to slidably receive a respective rod 31 extending up from the base 27, permitting movement of the platens along the rods. As seen in FIG. 1A, the stand 1 has an upper locking mechanism, generally designated 46, that comprises a toggle bar 47 having ends 47A received in respective slots in the sleeves 43, 45 of the upper platen 37. A set knob 48 is threadably received in an adjustment block 49 fixedly attached to the upper platen 37. The toggle bar 47 is resiliently flexible and is aligned with an opening in the adjustment block 49 that receives the set knob 48 so that the end of the knob contacts the toggle bar 47 when the knob is advanced through the block. The position of the upper platen 37 is fixed at a desired vertical position by turning the set knob 48 to advance the knob so the end of the knob presses against the toggle bar 47 causing ends of the bar to press against respective rods 31. It will be understood that the upper platen 37 will be held in place by the force from the knob 48 pressing against the toggle bar 47 so that the ends of the toggle bar press against the rods 31 to lock the upper platen in place. In the unlocked position with the knob 48 withdrawn from the adjustment block, the ends 47A of the toggle bar 47 are in sliding engagement with the rods 31 allowing the upper platen 37 to be vertically positioned. The stand 1 has an actuator mechanism, generally designated 53, housed in the base 27 for vertical positioning of the lower platen 39 on the rods 31. As will be described below in more detail, the stand 1 is configured so that the cartridge 7 may be supported between the upper platen 37 and lower platen 39 so that fluid from the upstream tubing 13 connected to the bottom platen may enter the column 5 and fluid discharged from the column flows out of the stand through the downstream tubing 19 connected to the upper platen. It will be understood that the HTFP system 3 could be configured so that the direction of flow through the stand 1 and column 5 is reversed (i.e., fluid enters the stand at the upper platen 37 and leaves the stand at the lower platen 39) without departing from the scope of this invention.

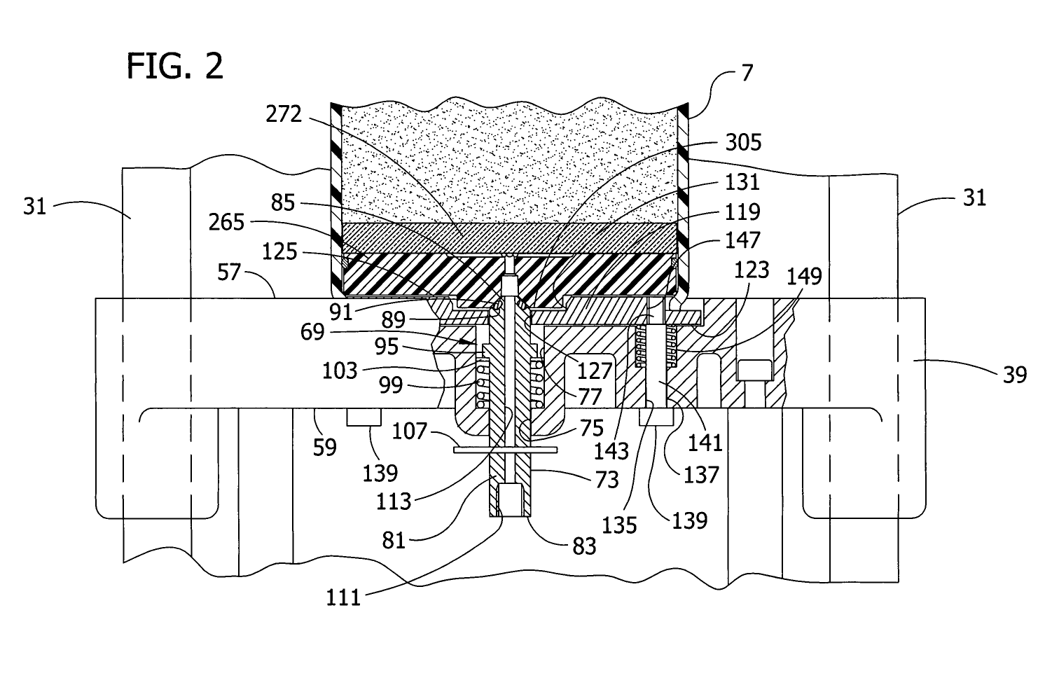

As seen in FIGS. 1 and 2, the opposed upper platen 37 and lower platen 39 each comprises a cast plate that is slidably mounted on the two rods 31 of the stand 1. In the illustrated embodiment, the construction of the upper platen 37 and lower platen 39 is substantially similar, with the platens being inverted and arranged in opposed relation. Accordingly, only lower platen 39 (shown in FIG. 2) will be described in detail. The lower platen 39 has an inner face 57 that supports the bottom of the chromatography cartridge 7 and an outer face 59 facing the base 27 of the stand 1. The top platen 37 has an inner face 63 that contacts the top of the chromatography cartridge 7 and an outer face 65 facing the head 33 of the stand 1. Each platen 37, 39 is of substantially similar construction, having a counterbored cylindrical central opening, generally designated 69, that slidably receives a nipple 73 connected to either the upstream tubing 13 or the downstream tubing 19. As best seen in FIG. 2 for the lower platen 39, the central opening 69 comprises a narrow opening 75 at the outer face 59 adjacent a larger diameter cavity 77 that opens to the inner face 57 of the platen. The nipple 73 is cylindrical with a first end 83 connected to the tubing 13 and a second free end 85 having a truncated conical tip with a groove 89 that receives a resilient O-ring 91. An annular shoulder 95 extends from the nipple 73 intermediate the first end 83 and second end 85 and is received in the cavity 77 in the lower platen 39. The lower platen 39 has a coil spring 99 housed in the cavity 77 that receives the nipple body 81 and urges the nipple 73 into fluid contact with the cartridge 7. The spring 99 contacts the platen 39 at one end and a washer 103 that abuts the lower face of the nipple shoulder 95 at its other end so that the force of the spring acts on the washer to urge the nipple 73 from the lower platen 39 in a direction toward the upper platen 37. A restraining plate 107 is connected to the external surface of the nipple body 81 outside of the cavity 77 and intermediate the first end 83 of the nipple 73 and the platen 39 so that the plate can contact the platen to limit the movement of the nipple towards the cartridge 7. Each nipple 73 has an internally threaded inlet 111 at the first end 83 for receiving a threaded male connector (not shown) on the end of the tubing 13 and an outlet passage 113 adjacent the inlet that passes through the truncated conical tip 85 of the nipple.

As shown in FIGS. 1 and 2, the inner faces 57, 63 of the upper and lower platens 37, 39 are indented to receive guide plates 119 that contact respective ends of the chromatography cartridge 7. It will be understood that the upper and lower guide plates 119 are of substantially similar construction with the lower guide plate being described below and shown in FIG. 2. Each guide plate 119 is an aluminum disk that is machined to have a substantially flat outer surface 123 that abuts the inner face of the platen 39 and a stepped inner surface 125 that is adapted to positively locate the chromatography cartridge 7. The guide plate 119 has a bore 127 axially aligned with the cavity 77 in the platen 39 to receive the spring loaded nipple 73 extending from the cavity through the guide plate. A locator recess 131 in the inner surface 125 of each guide plate 119 is co-axial with the guide plate bore 127 so that the tip 85 of the nipple 73 extends into the recess. The recess 131 positively locates the bottom end of the cartridge 7 on the lower platen 39 and the top end of the cartridge on the top platen 37 so that the cartridge can be quickly and easily located for fluid communication with the upper and lower nipple 73. Each platen 37, 39 has four circumferentially spaced cavities 135 (only one is shown) that receive a guide fastener (e.g., a bolt 137) having a head 139 engaging the outer face 59, 65 of each platen, a non-threaded intermediate portion 141 for secure attachment to the platen, and a threaded distal end portion 143 protruding from the indented inner face 57, 63 of each platen. As best seen in FIG. 2, the guide plate 119 has holes 147 which receive the threaded portions 143 of the fasteners 137 and is slidably movable relative to the lower platen 39 on the fasteners. The lower platen 39 has a guide plate spring 149 housed in each cavity 135 and surrounding a portion of the bolt 137. The guide plate spring 149 bears against the lower platen 39 at one end and the guide plate 119 at the other end, biasing the guide plate away from the lower platen. Thus, the guide plate 119 on the lower platen 39 can move independently with respect to the lower platen to facilitate loading of the cartridge 7 in the stand 1. It will be understood that the upper platen 37 of the stand 1 is configured similar to the lower platen 39 except that the guide plate 119 is fixedly attached to the upper platen by a threaded fastener (not shown) and the guide plate spring 149 on the lower platen is eliminated. The stand 1 could comprise upper and lower platens 37, 39 having guide plates 119 fixedly attached to each platen or having the locator recess (corresponding to locator recess 131) made integral with the inner face of each platen without departing from the scope of this invention.

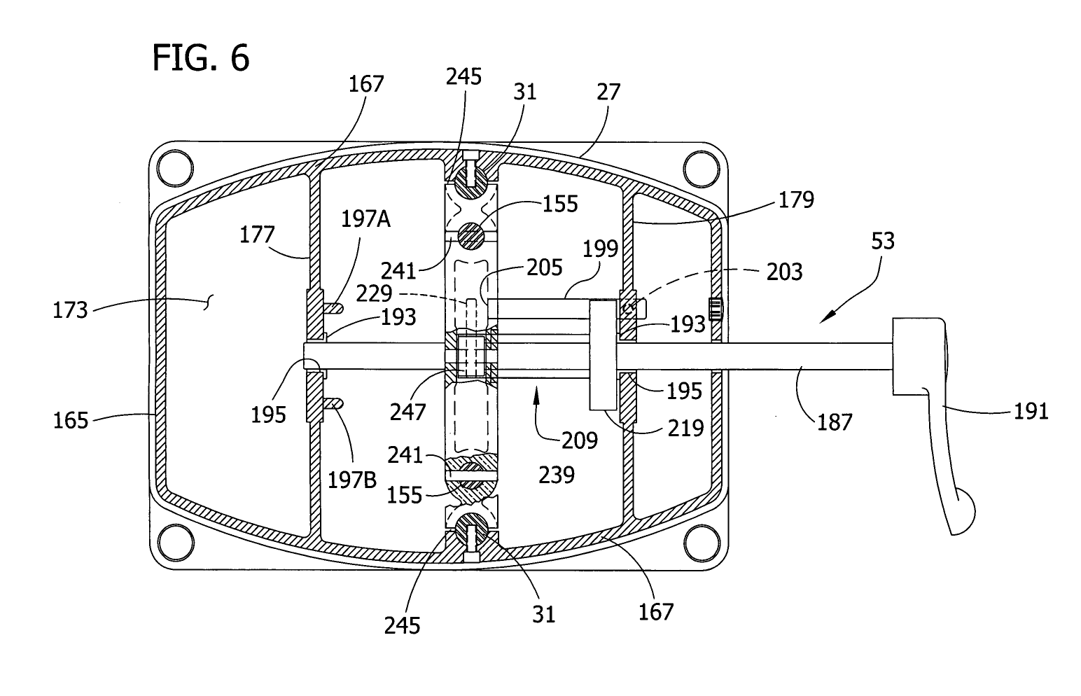

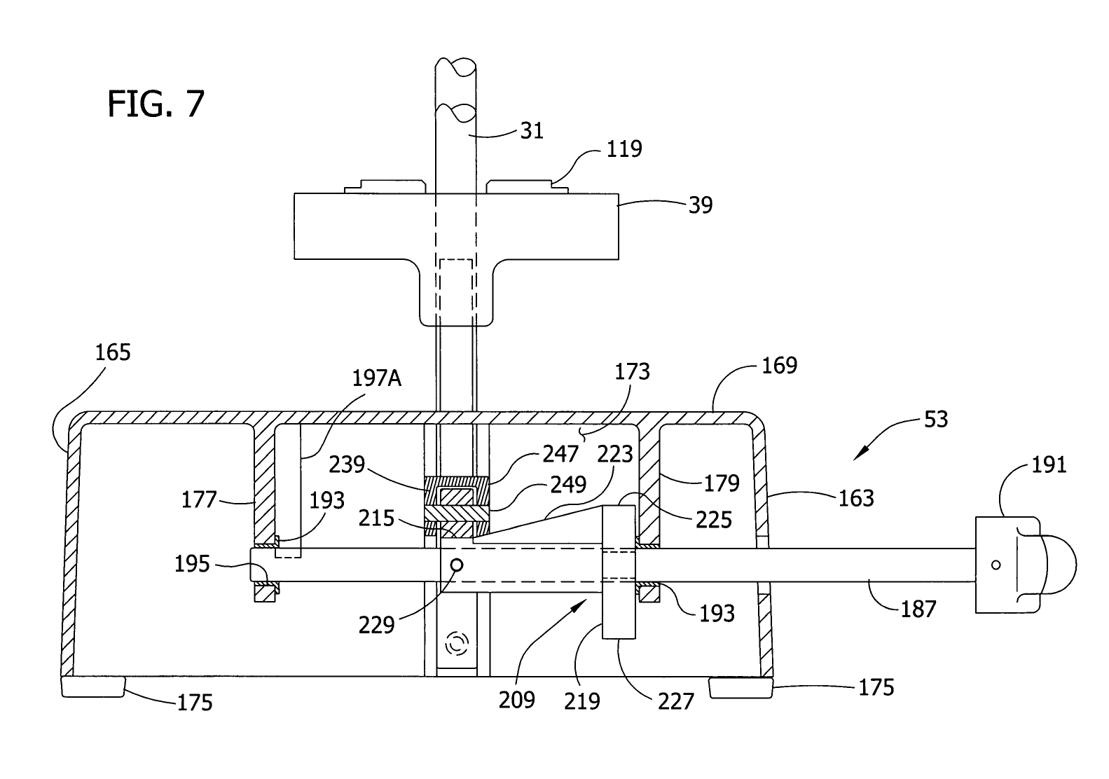

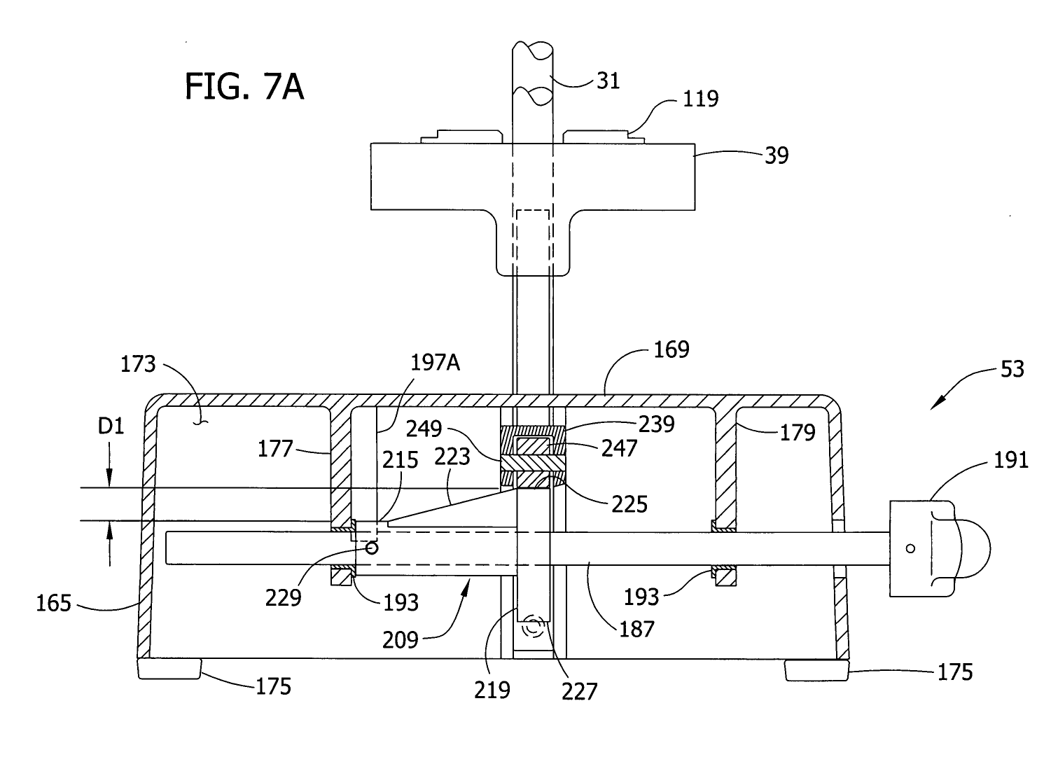

The lower platen 39 is attached to the actuator mechanism 53 housed in the base 27 by two vertical support posts 155 that are fixedly attached to the platen by threaded fasteners 157. As shown in FIGS. 6 and 7, the base 27 has a housing comprising a front wall 163 and rear wall 165, curved side walls 167, and a top wall 169 connecting the front, rear and side walls to form a substantially enclosed space 173 when the stand rests on a surface such as a counter top (not shown). The stand 1 has rubber feet 175 at the bottom of each comer of the base 27 for contact with the counter top. Two generally parallel ribs 177, 179 are formed integrally with the cast base 27 and descend from the top wall 169 within the enclosed space 173. The actuator mechanism 53 comprises a shaft 187 that has one end protruding from a side wall 167 of the base 27 and a second end housed in the enclosed space 173. The protruding end of the shaft 187 mounts an actuator crank 191. The ribs 177, 179 each have a sleeve bearing 193 press fit into an aligned opening 195 that receives the shaft 187 and allows rotation and translation of the shaft with respect to fixed base 27. In the illustrated embodiment, the rib 177 has two stops 197A, 197B protruding from the rib toward the center of the base 27 and located on opposite sides of the aligned opening 195. Each stop 197A, 197B extends from the top wall 169 of the base 27 to a bottom edge located above the centerline of the aligned opening 195 and the shaft 187. A locking bar 199 is housed in the base 27 and fixedly attached to the other rib 179 by a threaded fastener 203 and extends from the rib toward the center of the base. The locking bar 199 is attached to the rib 179 so that a free end 205 of the locking bar is positioned off the centerline of the enclosed space 173. A cam, generally indicated 209, attached to the shaft 187 intermediate the ends of the shaft 187 is housed in the base housing 27 between the downwardly extending ribs 177, 179.

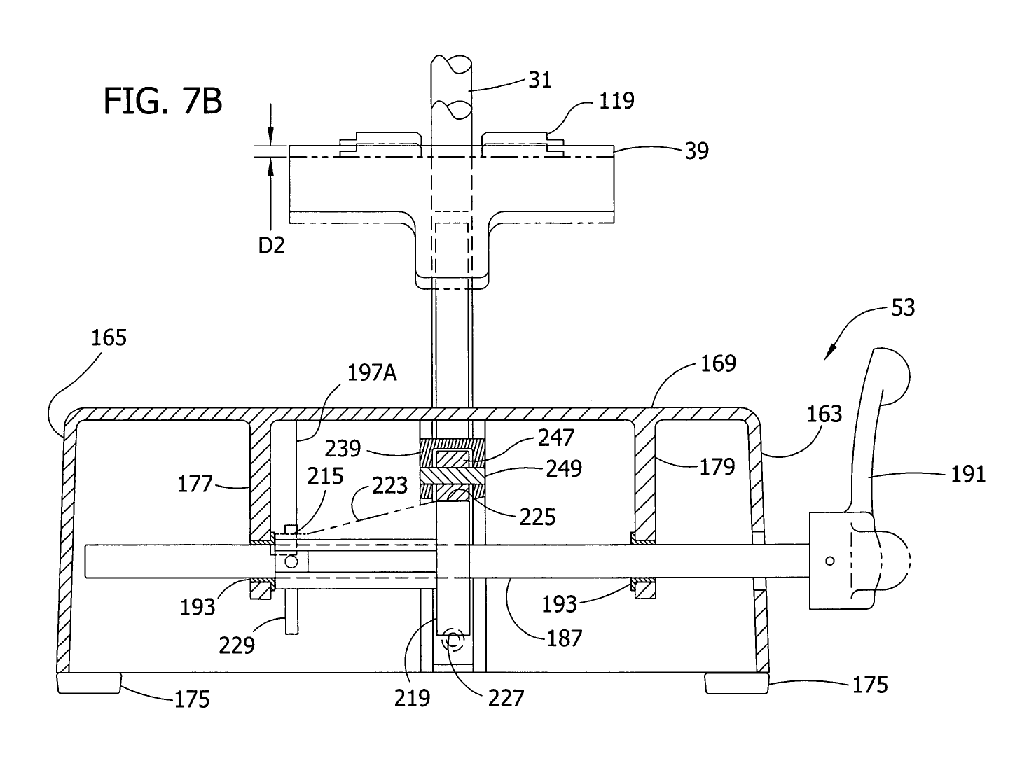

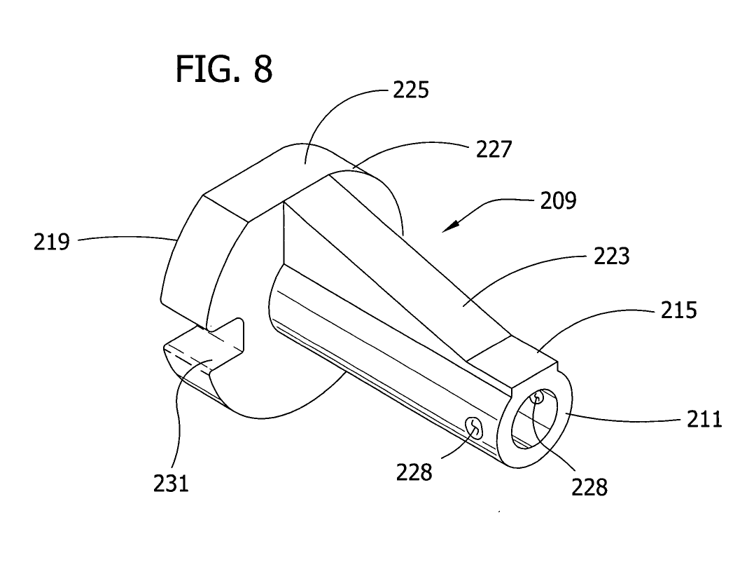

As seen in FIG. 8, the cam 209 has a hollow sleeve 211 for receiving the shaft 187, a first land 215 on the top of the sleeve at one end of the cam, a contoured disk 219 at an opposite end, and a first camming surface in the form of a ramp 223 adjacent the first land that connects the first land with a second land 225 on a peripheral surface 227 of the disk. The cam 209 has a hole 228 in each side of the hollow sleeve 211 for receiving a pin 229 (FIG. 6) that locks the cam onto the shaft 187. The pin 229 passes through the holes 228 in the hollow sleeve 211 that are aligned with corresponding holes (not shown) in the shaft 187. It will be understood that the pin 229 is sized for a press fit through the cam 209 and shaft 187 so that the position of the cam on the shaft if fixed. As shown in FIG. 6, one end of the pin 229 extends radially outward from the shaft a substantial distance. The peripheral surface 227 of the disk 219 is smooth except at a notch 231 for receiving the locking bar 199 attached to the rib 179 in the base 27. The locking bar 199 is received in the notch 231 to engage the cam 209 to prevent the cam and the shaft 187 from turning prior to full insertion of the shaft in the base 27. The peripheral surface 227 of the disk 219 is eccentric of the axis of the shaft 187, forming a second camming surface comprising second land 225 that moves the lower platen 39 upon rotation of the shaft 187. Preferably the cam 209 is made from an aluminum-zinc alloy but it will be understood that the cam may be made from other materials and have other configurations (e.g., conical) without departing from the scope of this invention.

The actuator mechanism 53 has a cross-piece 239 (broadly “cam follower”) fixedly attached by locking pins 241 to the lower ends of the vertical support posts 155 that extend into the enclosed space 173 of the base 27 (FIG. 6). Referring to FIGS. 6-7B, the cross-piece 239 has two arcuate ends 245 each end being shaped for slidable engagement with a respective rod 31 that extends through the base 27. The cross-piece 239 has a cam roller 247 mounted for rotation in the center of the cross-piece by a connecting pin 249 and aligned with the ramp 223 of the cam 209 as illustrated in FIGS. 6-7A. The cam roller 247 rests on the first land 215 adjacent the ramp 223 and is aligned for sliding contact with the inclined ramp surface upon translational movement of the shaft 187 resulting from an inward thrust of the crank 191. As the shaft 187 is inserted into the stand 1, the sliding contact of the cam roller 247 on the ramp 223 of the cam 209 causes an upward coarse movement of the cross-piece 239 and the lower platen 39.

FIG. 7A shows the shaft 187 fully inserted into the housing 27 so that the cam roller 247 is positioned on the second land 225 of the contoured disk 219 and the lower platen 39 is raised a distance D1 equal to the height of the ramp 223. In the position shown in FIG. 7A, the cam 209 has been inserted in the base 27 so that the contoured disk 219 is located past the free end 205 of the locking bar 199 so that the locking bar no longer engages the notch 231 on the disk allowing the cam and shaft 187 to be freely rotated in the base. The actuator mechanism 53 is configured so that the rotation of the shaft 187 is limited by the contact of the pin 229 with the lower edge of the stops 197A,197B on the rib 177. From the fully inserted position of FIG. 7A, the shaft 187 can be rotated only in a clockwise direction (from the perspective of someone facing the front wall 163 of the base 27). The stop 197A blocks the projecting portion of the pin 229 to prevent any counterclockwise rotation of the shaft 187 from the position shown in FIG. 7A. The other stop 197B is positioned for contact with the pin 229 upon approximately 180° of clockwise rotation of the shaft 187. Upon rotation of the crank 191 connected to the shaft 187 the lower platen 39 is forced further upward a distance D2 (FIG. 7B) as the cam roller 247 moves along the peripheral surface 227 of the contoured disk 219 over regions of the peripheral surface 227 spaced progressively farther from the axis of the shaft. The upward movement of the cross-piece 239 and the lower platen 39 in response to the rotation of the shaft 187 provides a fine movement of the bottom platen for final positioning of the bottom platen relative to the top platen. The rotation of the crank 191 compresses the cartridge 7 and lower platen 39 against the fixed upper platen 37 so that an axial compression force acts downward on the cam roller 247 substantially perpendicular to the peripheral surface 227 of the contoured disk so that the position of the roller on the peripheral surface of the cam is self locking and does not provide or force tending to rotate the cam 209. In one embodiment, the distance D1 equal to the height of the ramp 223 is approximately 1 inch and the distance D2 is approximately 0.2 inches. The amount of rotation of the crank 191 required to compress the cartridge between lower platen 39 and upper platen 37 will vary depending on the length of the cartridge and the positioning of the upper platen. Although 90 degrees of rotation is shown in FIG. 7B, the shaft 187 may be rotated by any amount up to 180 degrees which is the full amount of rotation allowed by the positioning of the pin 229 and the stops 197 of the actuator mechanism 53. It will be understood that the upper platen 37 may be positioned so that the translational movement of the shaft 187 from the position shown in FIG. 7 to the position shown in FIG. 7A locks the cam 209 and the lower platen 39 at the required position, compressing the cartridge 7 without requiring any clockwise rotation of the crank 191 (FIG. 7B).

As seen in FIG. 1, the upper platen 37 is a cast plate substantially similar to the lower platen 39 except the upper platen is held at a fixed vertical position on the stand by turning the set knob 48 of the upper locking mechanism 46 to lock the upper platen on the rods 31. Typically the upper platen 37 is moved to a desired height and locked by turning the set knob 48 so that the aforementioned movement of the lower platen 39 by the actuator mechanism 53 permits the cartridge(s) 7 to be installed or removed from the stand 1. In one typical loading sequence the bottom actuator 53 is first positioned in the “load position”, shown in FIG. 7, where the shaft 187 is extended from the base 27 and the lower platen 39 is at the lowest position. The load position allows the lower platen 39 to be spaced far enough away from the upper platen 37 so that a cartridge 7 can be easily loaded into the stand 1 between the plates 37,39 with the cartridge 7 in contact with the guide plate 119 in the lower platen 39. During loading, the spring loaded nipple 73 in the lower platen 39 extends through the guide plate 119 to contact the cartridge 7, while the upper platen and guide plate are spaced above the cartridge to allow the cartridge to be easily located on the lower platen.

Next, the actuator 53 is moved to the “idle position”, shown in FIG. 7A (and in phantom in FIG. 7B), by pushing the crank 191 in towards the front wall 163 of the base 27 so that the cam roller 247 slides up the ramp 223 of the cam 209 to reach the second land 225 on the peripheral surface 227 of the contoured disk 219 moving the lower platen 39 up by a distance D1. In the idle position, the cam 209 is inserted far enough into the base 27 so that the notch 231 in the disk 219 is disengaged from the locking bar 199 in the base 27. At the idle position, the top platen 37 can be lowered, if needed, so the guide plate 119 and spring loaded nipple 73 contact the top of the cartridge 7 to hold the cartridge in the stand by a loose fitting engagement with the top and bottom platen. At the idle position the nipples 73 in the upper and lower platen 37, 39 contact the cartridge 7 but are not yet in tight fluid sealing engagement with the cartridge. Prior to operation of the HTFP system 3, the actuator mechanism 53 is put in the “operate position”, shown in FIG. 7B, by turning the crank 191 in a clockwise direction from FIG. 1 so that the cam roller 247 moves the lower platen 39 and cartridge 7 upward a distance D2 against the fixed upper platen 37, compressing the cartridge between the platens. At the operate position, the nipples 73 in the top and bottom platen 37, 39 are in tight sealing engagement with respective ends of the cartridge 7 to prevent leakage of the HTFP system 3.

In one preferred embodiment that top platen 37, lower platen 39, and the base 27 are made from aluminum-zinc alloy castings, the guide plates 119 and the rods 31 are fabricated from aluminum, and the nipples 73 are made from plastic (e.g., TECHTRON® or PEEK®). It will be understood that the components of the stand 1 could be made from other suitable materials without departing from the scope of this invention.

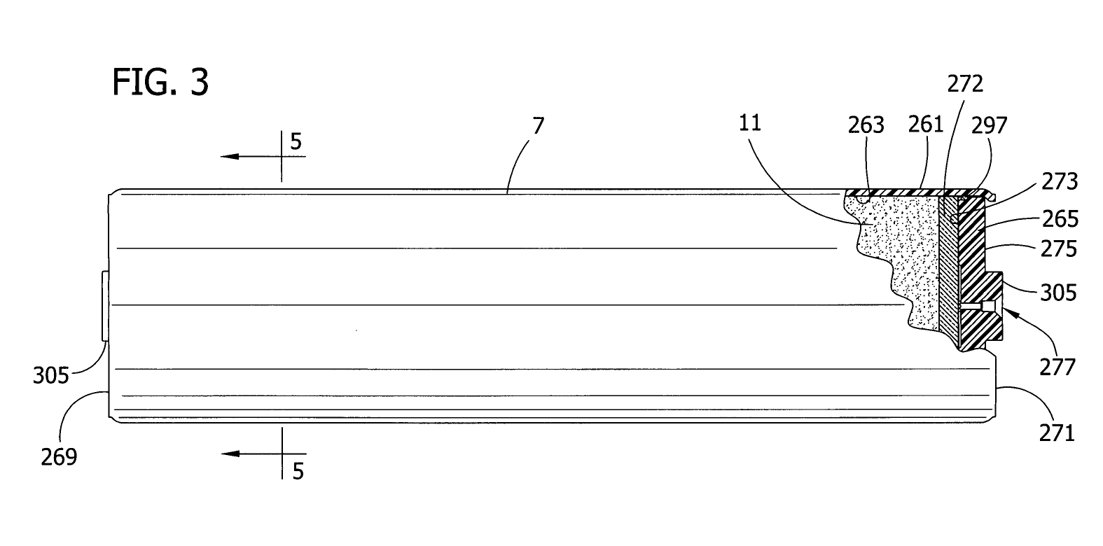

Referring now to FIGS. 3 thru 5, the chromatography cartridge 7 for use in the chromatography stand 1 comprises an open ended cylindrical tube 261 having an inner surface 263 that receives a pair of identical end caps 265 arranged to define a closed inlet end 269 and a closed outlet end 271 of the cartridge. The cartridge 7 is filled with chromatography media (e.g., silica gel) 11 that is contained between frits 272 located adjacent the end caps 265. The frits 272 contact the media 11 on one side and the end caps 265 on the other side to prevent the media from flowing out of the cartridge 7. The frits 272 are made from sintered particles (e.g., polyethylene or PTFE) compressed to produce a porous material having pores that run through the material enabling the frit to act as a filter. The frits 272 are positioned in the cartridge 7 to retain the chromatography media 11 and allow fluid to flow to and from respective end caps 265. In the illustrated embodiment, the identical end caps 265 at the inlet and outlet of the cartridge 7 are configured to be received in either the upper or lower platen 37, 39 so that the cartridge may be loaded in the stand 1 in either the orientation shown in FIG. 1 or an orientation rotated 180° where the end 269 of the cartridge is the outlet and the end 271 of the cartridge is the inlet. The reversibility of the cartridge 7 in the chromatography stand 1 allows the separation to be performed in one flow direction and a flushing operation to be performed in the opposite flow direction that may be required to remove the purified compound of interest remaining in the cartridge. The reversibility of the cartridge 7 allows the flushing operation to remove the purified compound of the interest to be performed on the same stand 1 as the sample purification by HTFP.

Referring generally to FIGS. 3 thru 5, each end cap 265 has an inner face 273 that contacts the frit 272, an outer face 275 defining an external end of the cartridge, and a central flow passage, generally designated 277 for the flow of fluid through the cap. As seen in FIG. 5, the central flow passage 277 has a truncated conical inlet 281 at the outer face 275 leading to a female luer fitting portion 283 with a slightly tapered cylindrical surface. The flow passage 277 has an outlet portion 285 of uniform diameter adjacent the female luer fitting portion 283 that opens to a series of radially extending grooves 289 on the inner face 273 of the end cap 265. The female luer fitting portion 283 allows a sealingly secure fluid connection between the end cap 265 of the cartridge 7 and any suitable device (not shown) having a male luer fitting (e.g., syringe or Solid Phase Extraction (SPE) module). The radial grooves 289 facilitate a uniform flow distribution of solvent at the inlet end 269 of the cartridge 7 and allow for collection of solvent and sample components at the outlet end 271 of the cartridge. A resilient O-ring 297 is received in a notch 299 around the periphery of each end cap 265 to seal against the passage of fluid and chromatography media between the outer edge of the end cap and the inner surface 263 of the cylindrical tube 261. Each end cap 265 is sealingly held in the tube 261 by the close friction fit between the O-ring 297 and the interior wall of the tube. In one embodiment, each end of the tube 261 is heat crimped and deformed inward to have a reduced diameter that engages the end cap 265 to hold the end cap in the tube. It will be understood that the end caps 265 can by retained in the tube 261 by other means (e.g., friction fit, interlocking grooves on the tube and the end cap, external clamps, etc.) without departing from the scope of this invention.

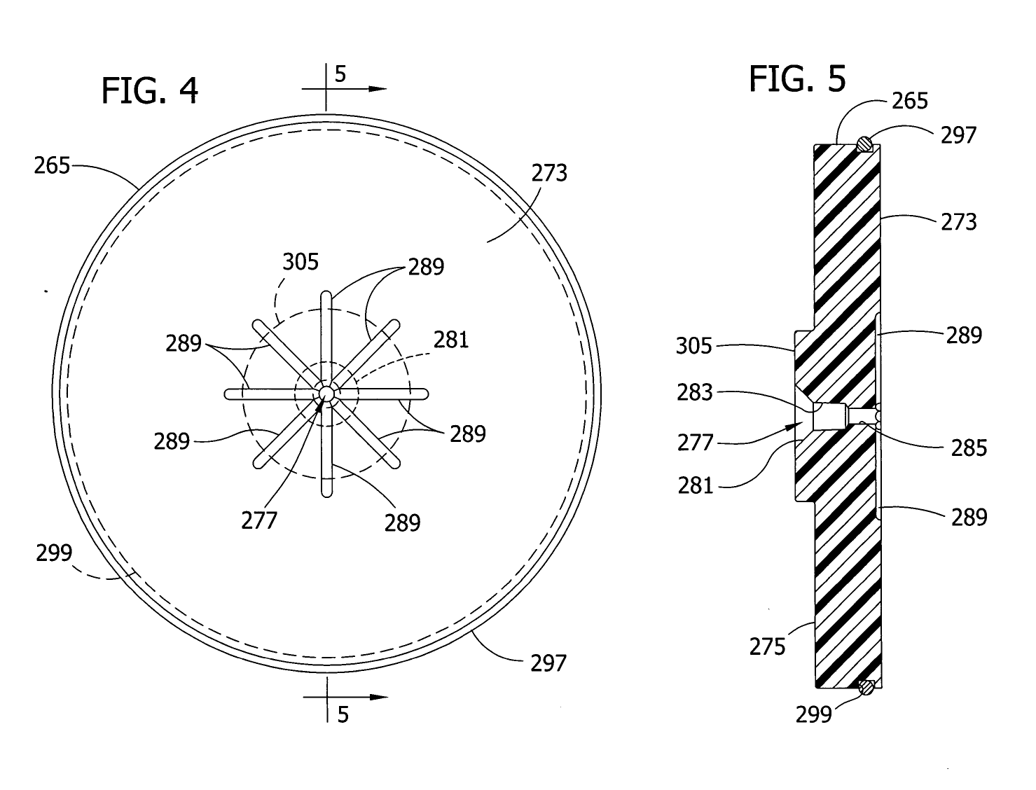

As shown in FIGS. 2-4, the outer face 275 of each end cap 265 has a connector portion 305 comprising a cylindrical projection axially aligned with the conical inlet 281 of the central flow path 277 and adapted for plug-in connection with the upper platen 37 or lower platen 39 of the stand 1 to allow fluid communication with the interior of the tube 261. The connector portion 305 projects axially outward from the outer face 275 of the end cap 265 to form a mating portion that is received in the recess 131 in the guide plate 119 to facilitate alignment of the cartridge 7 in the stand 1. As seen in FIGS. 1 and 2, the cartridge 7 with opposed end caps 265 is mounted on the stand 1 by placing the connector portion 305 of each end cap 265 in the respective recess 131 in the guide plate 119 of the top and bottom platen 37, 39. After the stand 1 is set to the operate position by turning the crank 191, the spring loaded upper and lower nipples 73 will project upwardly from lower platen 39 and downwardly from upper platen 37 so that the conical tip 85 of the nipple is received in the conical inlet 281 of the central flow path 277 of each end cap 265. The O-ring 91 held in the groove 89 of the nipple 73 will be compressed to seal against the inlet portion 281 of the end cap 265 by the spring force biasing the nipple outward from each platen 37, 39 as well as the compressive force created by the final positioning of the bottom platen. The spring loaded guide plate 119 in the lower platen 39 is particularly useful in facilitating loading of a cartridge that may have an end cap 265 that is slightly canted with respect to the tube 261. It will be understood that spring loaded guide plate 119 in the lower platen 39 will contact the end of the cartridge tube 261 and provide a flush contact surface area with the outer face 275 of each end cap 265.

In one embodiment the cartridge 7 is constructed from a tube 261 have an inner diameter of approximately 40 mm with a wall thickness of about 2.54 mm. In another embodiment, the cartridge 7 has a tube 261 with an inner diameter of approximately 80 mm and a wall thickness of about 3.56 mm. The lengths of the cartridges 7 may vary but typically the cartridge is constructed from a tube 261 having a length ranging from about 7.5 cm to about 30 cm. The end caps 265 are typically sized to be received in the open ends of the tubes 261 and may have an overall diameter of about 39.60 mm for a tube having an inner diameter of 40 mm or a diameter of about 79.60 mm for a tube having an inner diameter of 80 mm. The cylindrical connector portion 305 of a typical end cap 265 projects axially outward from the outer surface 275 of the end cap about 2.9 mm and has a diameter of about 25.0 mm. The connector portion 305 projects axially outward from the end of the tube 261 by at least about 2 mm; more preferably between about 3 mm to about 5 mm; and most preferably about 4 mm. The mating recess 131 in the guide plate 119 is sized to receive the connector portion 305 of the end cap 265 and typically has a depth of about 3.2 mm from the surface of the guide plate with a diameter of about 25.4 mm. The foregoing dimensions are exemplary and do not limit the scope of the present invention.

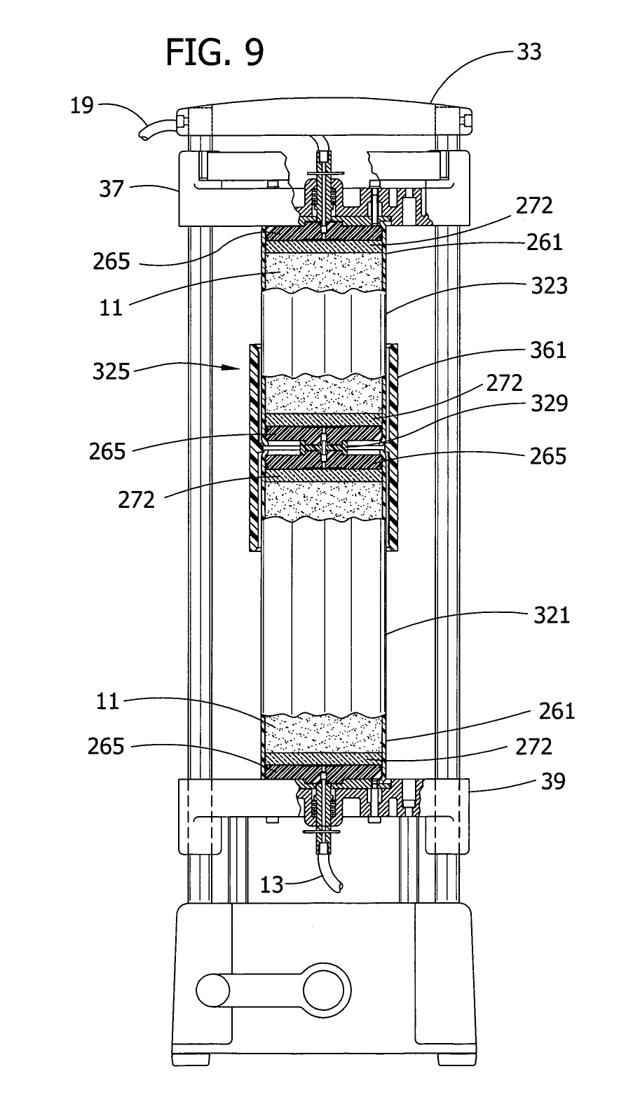

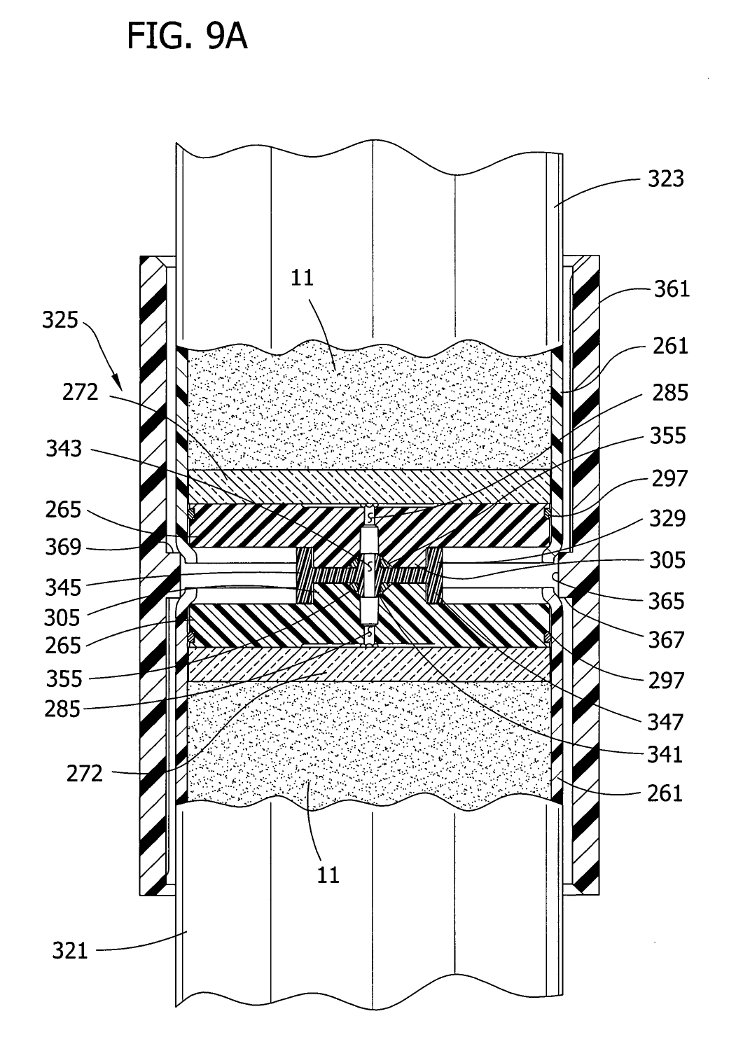

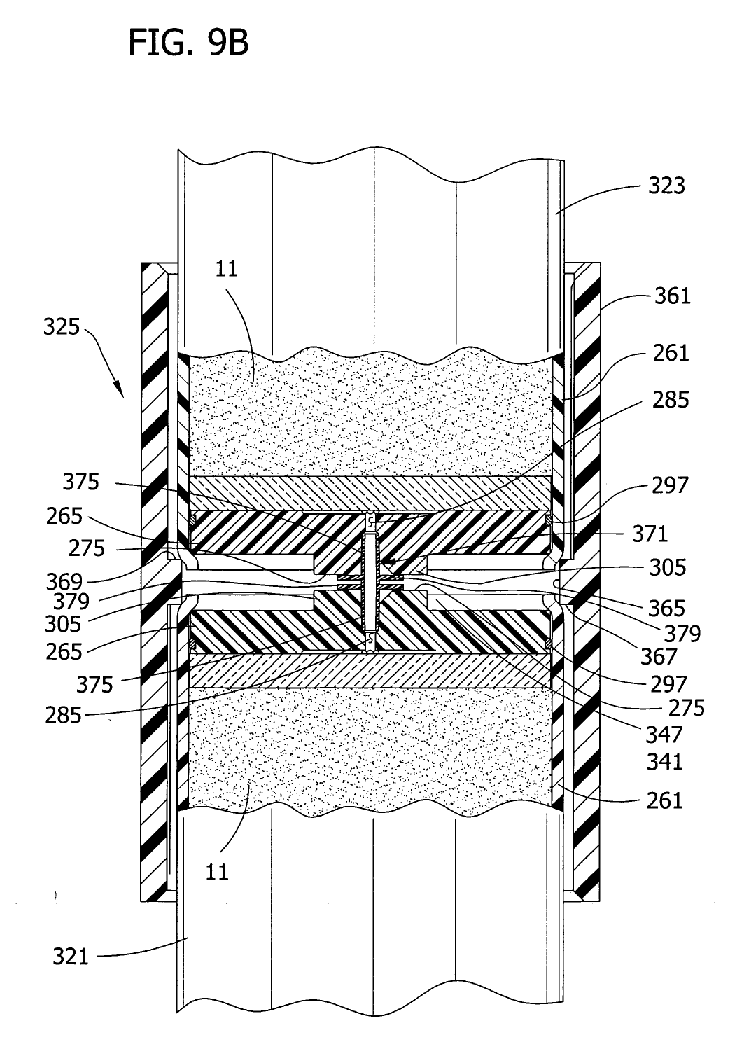

The chromatography stand 1 of the present invention is configured to be operatively connected to a chromatography column 5 that can comprise a single cartridge 7 (FIG. 1) or a plurality of cartridges operatively connected in a stacked arrangement in the stand (FIG. 9). As shown in FIG. 9, the upper platen 37 of the stand can be raised to accommodate two stacked cartridges 321, 323 resulting in a longer combined column height than a single cartridge. Alternatively, the upper platen 37 and lower platen 39 may be positioned to accommodate a single cartridge having a column height shorter or longer than the column height of the single cartridge 7 shown in FIG. 1, or the top and bottom platen may be positioned to accept more than two stacked cartridges. It will be understood that the required length of column height in the stand will vary depending on the specific characteristics and requirements of the sample being purified in the HTFP system.

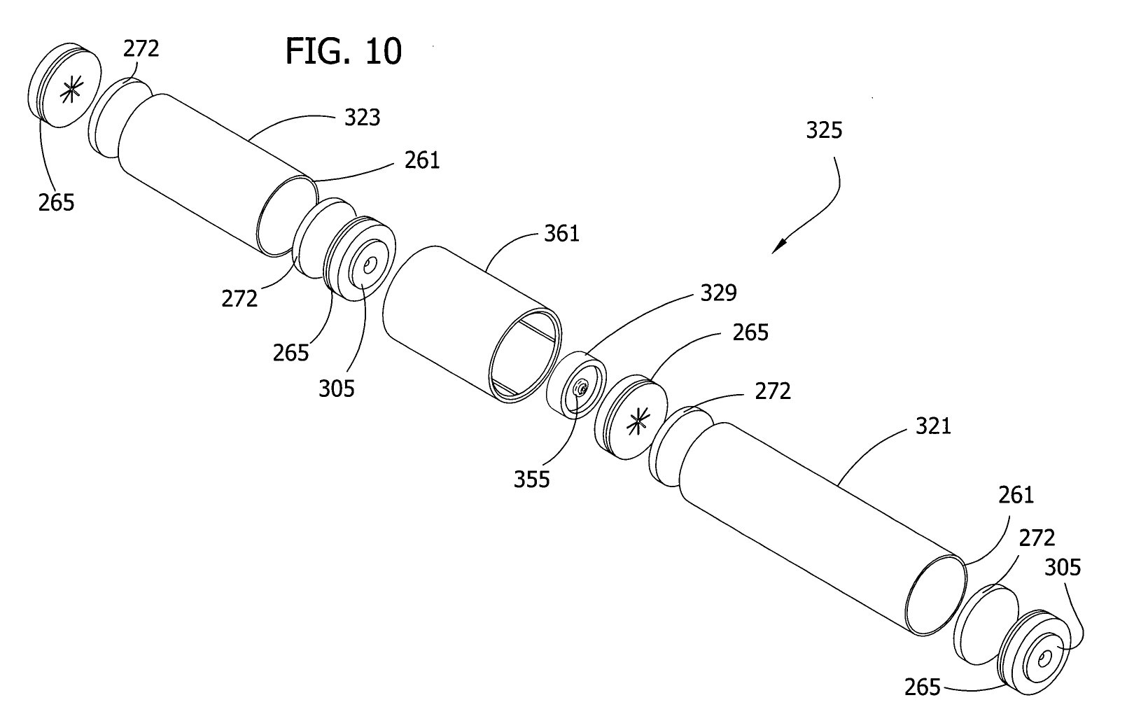

As seen in FIGS. 9 and 10, a chromatography column 32 of the present invention, generally indicated 325, comprises the first lower cartridge 321 in fluid-tight connection with the lower platen 39 of the stand 1, the second upper cartridge 323 in fluid-tight connection with the upper platen 37 and axially aligned with the first cartridge in a stacked arrangement. A coupler 329 is held between the respective cartridges for fluid-tight connection between the cartridges. Each cartridge 321, 323 in the set 325 is constructed in accordance with the above description of the cartridge 7 shown in FIGS. 3-5 in that each cartridge comprises a open ended tube 261 closed by two opposed end caps 265 received in the tube and having adjacent frits 272 with chromatography media 11 held therebetween. The connector portion 305 of each end cap 265 defines the outermost end of each cartridge 321, 323 in the set 325 to allow plug in connection with the stand 1 or with the coupler 329. Although two cartridges 321, 323 are shown in the cartridge set 325 of FIGS. 9 and 10, it will be understood that more than two cartridges could alternatively be provided in a stacked arrangement having a coupler 329 located between the adjacent end caps 265 of the cartridges.

As best seen in FIG. 9A and 12, the coupler 329 is a solid, thin disk that is sized to receive the connector portion 305 of the upper end cap 265 of the lower cartridge 321 and the connector portion of the bottom end cap of the top cartridge 323. The coupler disk 329 includes a nipple 341 with an axial opening 343 passing through the disc, an annular rim 345 at the peripheral edge of the disc, and an annular web 347 connecting the rim and the nipple. The web 347 and rim 345 define an annular cavity 351 on each side of the coupler 329. A resilient O-ring 355 is received around each end of the nipple 341 and is located in both annular cavities 351. The annular cavity 351 on each side of the coupler 329 is sized to receive the connector portion 305 of an adjacent end cap 265 of the stacked cartridge set 325. When the stacked cartridges 321, 323 are loaded into the stand 1, the compression forces created by the positioning of the upper platen 37 and lower platen 39 presses the nipple 341 of the coupler 329 and the resilient O-rings 355 against the conical inlet 281 of each end cap 265 to create a tight sealing connection for the flow of fluid between adjacent cartridges through the coupler. As shown in FIG. 9A, the axial opening 343 of the coupler 329 is sized the same as the outlet portion 285 of the central flow passage 277 of each end cap 265 so that the pressure drop resulting from the fluid flow between the cartridges is minimized and purification performance of the cartridge set 325 is maintained.

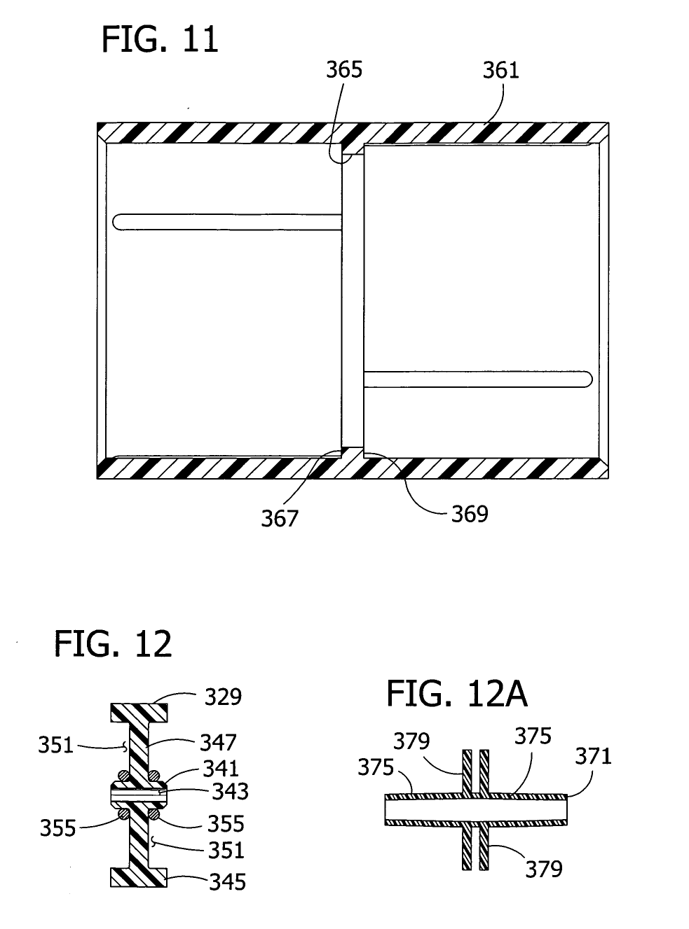

As shown in FIGS. 9-11, the cartridge set 325 also comprises a sleeve 361 that holds the coupler 329 and respective ends of the stacked cartridges 321, 323 to facilitate alignment of the connector portions 305 of the cartridges 265 for registration with the mating recesses 351 of the coupler. As seen in FIG. 9A and 11, the sleeve 361 has an annular shoulder 365 having a first end 367 for contact with the lower cartridge 321 and a second end 369 for contact with the top cartridge 323. The sleeve 361 assists assembly of the stacked cartridges 321, 323 and the coupler 329 and also provides a more finished look to the cartridge set 325 by providing a smooth external surface covering the joint between the coupler and the stacked cartridges. It will be understood that the sleeve 361 may be configured to receive cartridges of different diameter without departing from the scope of this invention.

FIG. 10 shows an exploded perspective view of the stacked cartridge set 325 of FIG. 9 removed from the stand 1 with the end caps 265 withdrawn from respective hollow tubes 261. In a preferred embodiment, the hollow tubes 261 are made from a transparent or translucent plastic material (e.g., polypropylene) and the end caps 265 and coupler 329 are made from a more rigid plastic (e.g., polyethylene). The resilient O-rings 355 on the coupler 329 may be made from ethylene propylene or any other suitable material without departing from the scope of this invention.

FIGS. 9B and 12A show a coupler (generally indicated at 371) of another embodiment that may be used to connect the adjacent end caps 265 of stacked cartridges 321, 323. The coupler 371 comprises two male luer fitting portions 375 that are received in the female luer fitting portion 283 of respective end caps 265. The coupler 371 has two parallel spaced apart flanges 379 at the base of respective male luer fitting portions 375 that contact the respective outer face 275 of the end caps 265. It will be understood that each male luer fitting portion 375 is slightly conical with a larger diameter near the flange 379 so that each male luer fitting portion mates with each female luer fitting portion 283 so that no gaskets are needed when using the coupler 371 in the stacked cartridge arrangement.

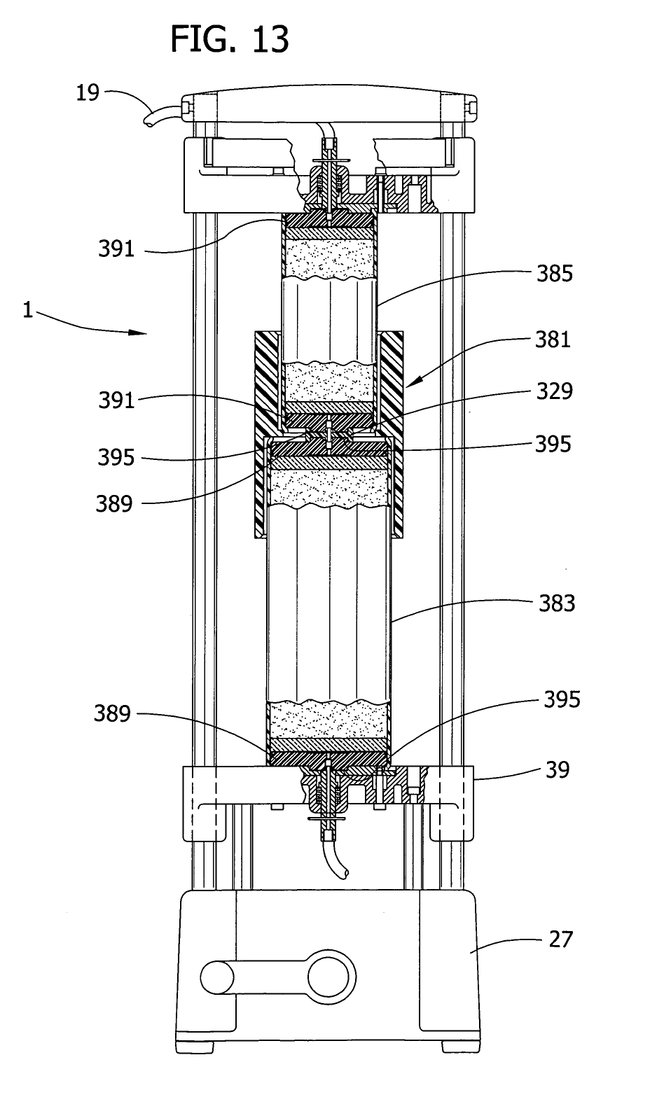

FIG. 13 shows another embodiment of a cartridge set 381 that includes a third cartridge 383 similar to the first cartridge 321 of FIG. 9 and a fourth cartridge 385 having a smaller diameter than the third cartridge. The third cartridge 383 and fourth cartridge 385 are connected in end to end relation with the coupler 329 of FIG. 12 that allows fluid communication between the third and fourth cartridge. The end caps 389 of the third cartridge 383 and the end caps 391 of the fourth cartridge 385 are each configured with identical connector portions 395 that may fit into the coupler 329 or the upper and lower platens 37, 39 of the stand 1. The consistent of the connector portion 395 of the end caps 389, 391 and the corresponding mating recess 351 of the coupler 329 allows the coupler to be interchangeably used with various sized cartridges or combination of cartridges that are held in stacked relation in the stand 1. Also, the configuration of the upper and lower platen 37, 39 with guide plate locator recess 131 (FIG. 2) that receives the connector portion 395 of a respective end cap 389, 391 allows the cartridges 383, 385 of variable diameter to be connected to the upper and lower platen of the stand 1.

The connector portions 305, 395 of the end caps 265, 389, 391 are configured for sealing connection with the locator recess 119 in either the upper or lower platen 37, 39 of the stand 1 so that the cartridges 7, 321, 323 can be orientated in either direction in the stand and can be reversed after a purification run of solvent through one direction of the cartridge. The reversibility feature permitted by the configuration of the stand 1 and cartridges 7, 321, 323 allows easy flushing of the purified compound of interest that frequently remains in the cartridge after the purification. The use of stacked cartridges 321, 323 allows a quick and easy method of extending the length of the separating media 11 used in the purification thus allowing more complex purifications to be run with the same equipment. For example, the stacked cartridges 321, 323 of the cartridge set 325 shown in FIG. 9 may be configured to contain different separating media to allow a bi-modal separation to occur with a single run of solvent through the stand 1. The first cartridge 321 could have filtration media 11 (e.g., diatomaceous earth) that acts as a filter to separate large molecules or impurities in the sample that might impede the purification process. The second cartridge 323 could have a finer separation media 11 (e.g., silica gel) to separate the remaining fine components of the sample. Also, as will be described below in more detail, one of the cartridges 321, 323 in the set 325 can be preloaded with solid sample prior to the loading the stacked cartridges on the stand 1 to facilitate separation of the sample prior to HTFP.

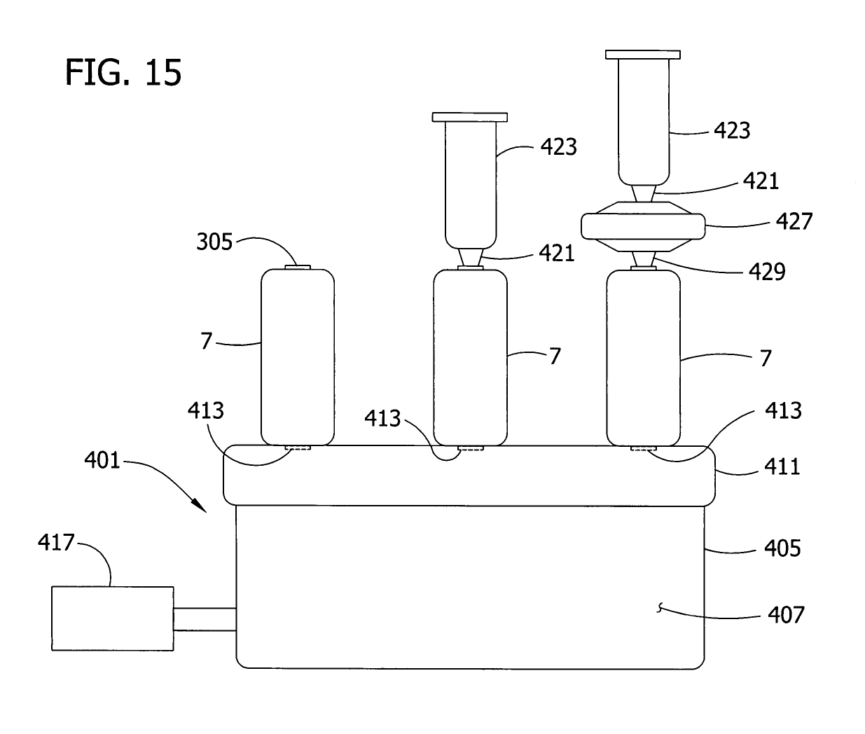

FIG. 15 shows a cartridge loading station of the present invention, generally indicated 401, that has a vacuum manifold 405 configured for loading sample onto three cartridges 7 prior to the cartridges being installed in the HTFP stand 1 (FIG. 1). The manifold 405 encloses a chamber 407 and has a top plate 411 with openings 413 to receive the connector portions 305 of the end caps 265 of the cartridges 7. A vacuum pump 417 connected to the manifold 405 evacuates air from the chamber 407 creating a vacuum that draws air through the cartridges 7 and into the chamber. After the vacuum pump 417 is operating, the sample may be introduced to the cartridge 7 through the central flow passage 277 (FIG. 5) of the top end cap 265 and pulled into the cartridge by the vacuum pump pulling air through the cartridge and into the chamber 407. After loading the sample into the cartridge 7, up to a column volume of weak solvent is added to the cartridge so that the sample is distributed in a section of cartridge media near the inlet of the cartridge. After the solvent is added, the cartridge 7 is removed from the vacuum manifold 405 prior to the components of the sample being fully separated from the sample and pulled through cartridge by the negative pressure in the vacuum chamber pulling the solvent through the cartridge. The cartridge 7 will be removed from the manifold 405 prior to solvent being discharged into the chamber 407 with the total loading time for the sample and solvent being typically about 20 seconds or less. The method of loading a sample into the cartridge 7 via the loading station 401 is facilitated by sealing connection between the female luer fitting portion 283 (FIG. 5) of the end cap 265 and a male luer fitting portion 421 of a sample holder 423 that may be used to introduce the sample to the cartridge. The sample holder 423 can be configured to have an internal filter media (i.e., charcoal) to filter unwanted impurities from the sample prior to loading the sample into the cartridge 7. It will be understood that the column volume of solvent may be introduced to the cartridge 7 through the sample holder 423 mounted to the end cap 265 of the cartridge. Also an external membrane type filter 427 with a male luer fitting 429 can be stacked between the cartridge 7 and the sampler holder 423 and connected to the female luer fitting 283 of the cartridge end cap 265 to filter the sample prior to cartridge loading. It will be understood that the sample holder 423 may be a solid phase extraction (SPE) module or a syringe body having male luer fitting portions 421 for sealing contact with the female luer fitting portion 283 of the end cap 265.

In operation, the chromatography column 5 of the present invention comprising a first and second chromatography cartridge, 321 and 323 respectively, mounted in the stand 1 and capable of independent use in the column, can be operated as part of the HTFP system 3 shown in FIG. 14. The cartridges 321, 323 are first coupled together in a stacked arrangement in generally end-to-end relation by placing the coupler 329 on the top end cap 265 of the lower cartridge, sliding the sleeve 361 over the upper end of the lower cartridge so that the shoulder 365 of the sleeve contacts the lower cartridge, and placing the lower end of the upper cartridge in the sleeve so that the lower end cap 265 is received in the coupler. As described above, the coupler 329 allows the transfer of fluid between the stacked cartridges 321, 323. The stacked cartridges coupler 329, and sleeve 361 are then placed in the stand 1 positioned in the “load position” so that the connector portion 305 of the lower cartridge is received in the locator recess 131 in the guide plate 119 of the lower platen 39. Next, the actuator mechanism is put in the “idle position” so that the upper and lower platen 37, 39 are in loose fitting engagement with respective cartridges 321, 323. The actuator mechanism 53 is placed in the “idle position” before making a final vertical adjustment that axially compresses the stacked cartridges 321, 323 and the coupler 329 so that a tight fluid seal is present between the platens and respective outer end caps 265 and the coupler and respective adjacent end caps of the cartridges.

After final compression of the stacked cartridges, the pump 15 is initiated to pump fluid from the supply container 23 into the spring loaded nipple 73 on the lower platen 39 of the stand 1. Fluid flowing into the nipple 73 is introduced into the first cartridge 321 and passes through the first cartridge, through the coupler 329 and into the second cartridge 323. A sample to be separated is either introduced to the solvent flow upstream of the stand 1 or a sample may be preloaded onto the first cartridge 321 prior to mounting the cartridges in the stand so that the carrier solvent conveys the sample though the column 5. The solvent passes through the second cartridge 323 carrying separated components of the sample at different timed intervals. The fluid carrying the separated components exits the column 5 through the downstream tubing 19 connected to the spring loaded nipple 73 in the upper platen 37 of the stand 1. The collection beaker 21 collects the discharge of the separated sample downstream of the second cartridge 323. It will be understood that the above described method of operation could be applied to the chromatography column 5 having a single cartridge 7 as shown in FIG. 1 or a stand having more than two cartridges (not shown) without departing from the scope of this invention.

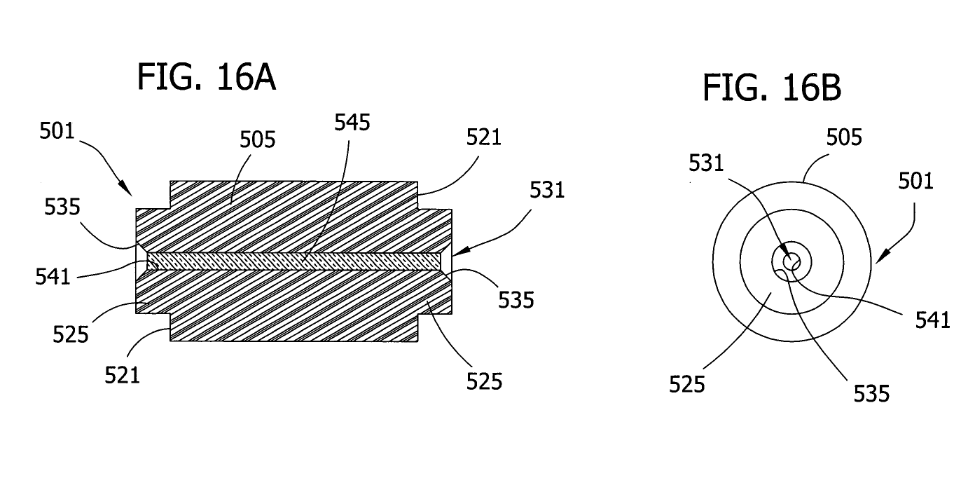

FIGS. 16A and 16B show one embodiment of a flushing connector, generally designated 501, for use in the chromatography stand 1. The flushing connector 501 is used to connect the upper and lower platens 37, 39 directly to each other (i.e., without any intervening cartridges) so that fluid can flow through the stand 1 to flush out any residual sample material and/or solvent after a sample has been separated by HTFP. The flushing connector 501 is a less expensive alternative to using a chromatography cartridge 7 for the fluid connection between the upper and lower platens 37, 39 that allows fluid to pass through the stand and the tubing of the stand to be cleansed between HTFP separations.

In the embodiment of FIGS. 16A and 16B, the flushing connector 501 comprises a generally cylindrical body 505 that has a first and second end adapted for connection to one of the upper and lower platens 37, 39 of the stand 1. The two ends of the body 505 are identically constructed for plug-in connection to the stand 1. Each end of the body has an outer face 521 that has a connector portion 525 substantially similar to the connector portion 305 of the end caps 265 of the chromatography cartridge 7. The body 505 has a passage generally indicated 531 passing from the outer face 521 of the first end to the outer face of the second end for the flow of fluid through the flush connector 501. The passage 531 has a truncated conical end 535 at each end of the body and an interior portion 541 of uniform diameter connecting the two conical ends. The connector portion 525 comprises a cylindrical projection axially aligned with the truncated conical ends 535 of the 531 passage and projecting axially outward from the outer face 521 of each end of the body 505. In the illustrated embodiment, the flushing connector comprises an insert 545 in the form of a porous frit press fit into the interior portion 541 of the passage 531 in the body 505. It will be understood that the insert 545 could comprise any material (e.g., polyethylene or PTFE) typically used to make porous frits without departing from the scope of this invention. The insert 545 retains fluid in the connector 501 after solvent has been flushed through the connector so that solvent does not discharge from the connector upon removal from the stand 1.

In one embodiment, the flush connector body 505 is approximately 76 mm long and has an outer diameter of about 38 mm. The cylindrical projection 525 of the flush connector 501 projects axially outward from the outer face of the body by about 8 mm and has a diameter of about 25 mm. The truncated conical inlet 535 of the passage 531 in the body 505 has an initial diameter of about 9.5 mm and the interior portion 541 of the opening has a diameter of about 4 mm. It will be understood that the foregoing dimensions are exemplary, and the connector 501 may have other dimensions without departing from the scope of the present invention.

In operation the flush connector 501 is positioned between the upper platen 37 and the lower platen 39 of the HTFP stand 1 in a similar manner as described above for the chromatography cartridge 7. Typically, the flushing operation using the flush connector 501 will take place between HTFP separations to flush out any sample or other particulate that may remain in the stand 1 after HTFP. After the connector 501 is loaded in the stand 1 and placed in tight fluid connection with the upper and lower platen 37 and 39, solvent is pumped through the stand so that solvent passes through the passage 531 in the connector. The insert 545 in the connector 501 allows solvent being pumped through the stand to pass through the connector and retains fluid in the connector after the flow of solvent is stopped so that the connector can be removed from the stand without spilling solvent. Once the flushing operation is complete and the connector 501 is removed from the stand 1, the stand is ready for loading a chromatography cartridge 7 for HTFP of a sample.

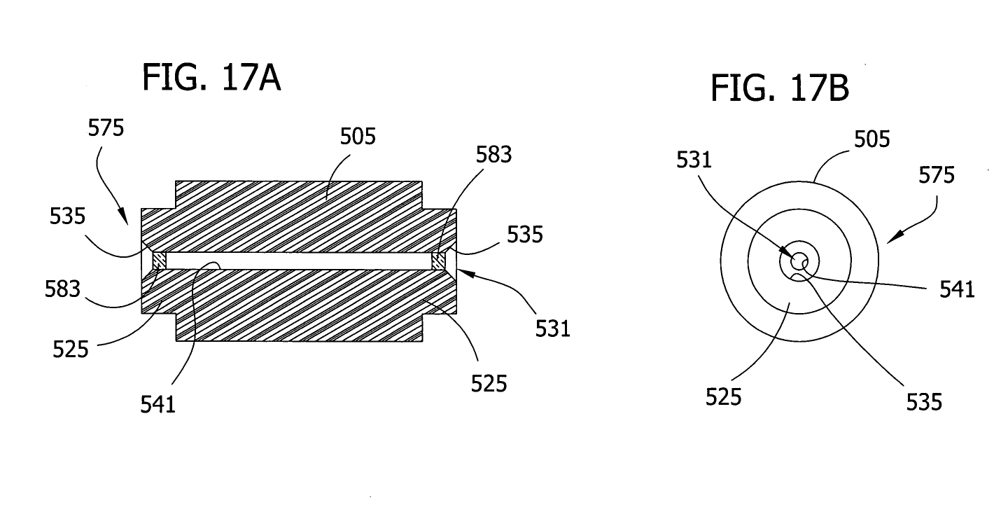

FIGS. 17A and 17B show a second embodiment of a flush connector of the present invention, generally designated 575. The connector 575 is substantially similar to the connector 501 of the first embodiment but has two separate inserts 583 press fit into the interior portion 541 of the passage 531 near each end of the connector body 505. Each insert 583 is a porous frit of similar material as the insert 545 of the first embodiment of the connector 501. The two inserts 583 serve the same function as the single insert 545 of the first embodiment in that the two frits retain solvent in the connector 575 after the flushing operation is completed.

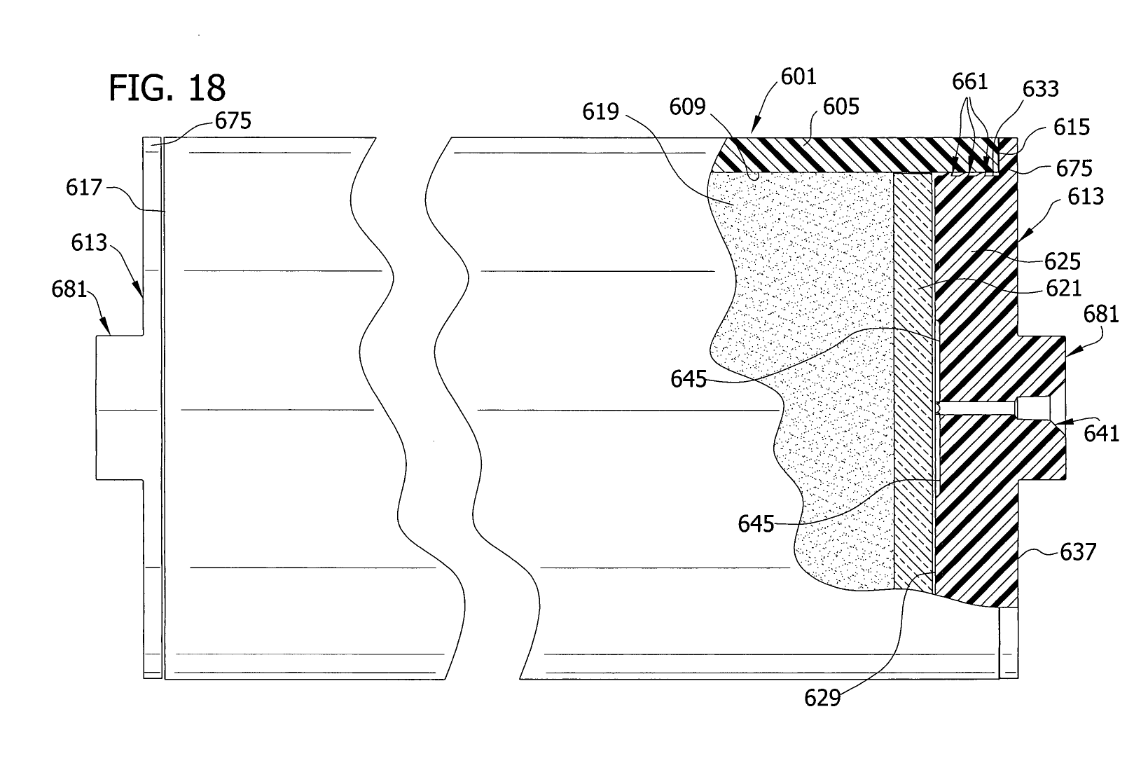

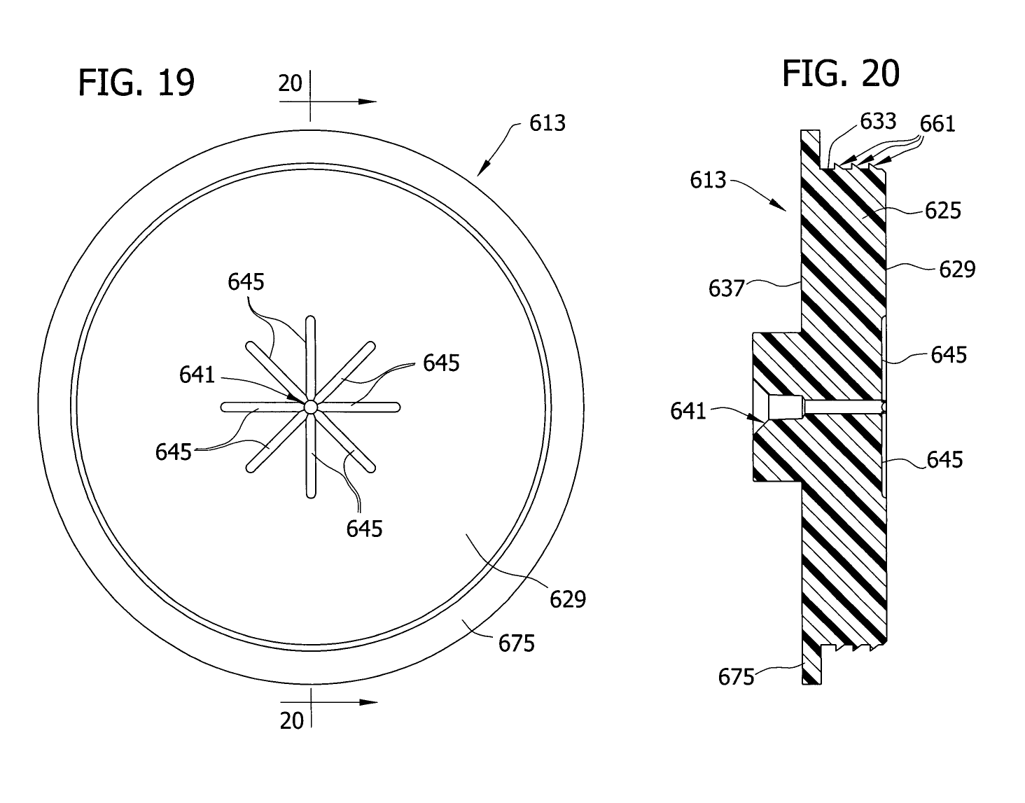

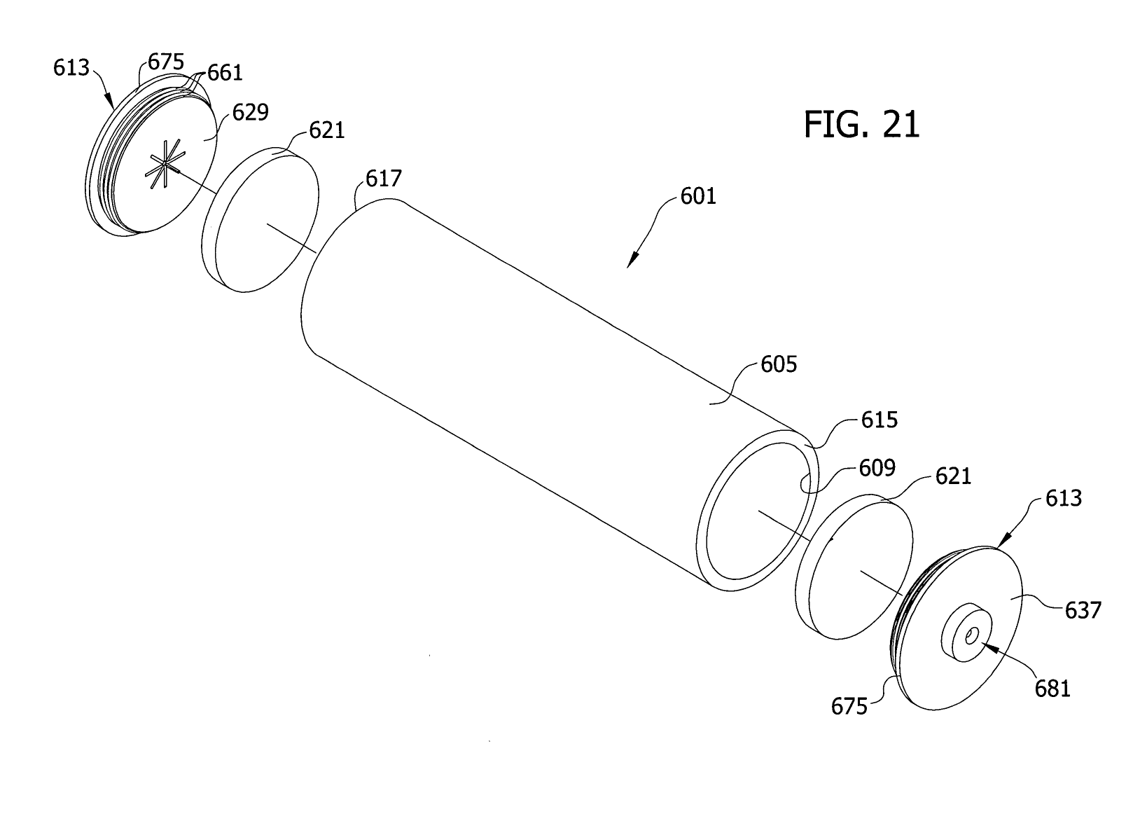

A second embodiment of the chromatography cartridge of the present invention, generally designated 601, is shown in FIGS. 18-21. This embodiment 601 is similar to the first embodiment in that the cartridge may be used in the chromatography stand 1. The cartridge 601 comprises an open ended cylindrical tube 605 having an inner surface 609 that receives a pair of identical end caps, generally indicated 613, arranged to define a closed inlet end and closed outlet end of the cartridge. The tube 605 has axially facing end surfaces 615, 617 at the open inlet and outlet ends of the tube. As with the previous embodiment, the cartridge 601 is filled with chromatography media (e.g., silica gel) 619 that is contained between frits 621 adjacent the end caps 613. It will be understood that the identical construction of the two end caps 613 of the cartridge 601 allows the cartridge to be installed in the stand 1 with either of the two end caps on top. Also, two cartridges 601 may be connected together by a coupler 329 (FIG. 9), 371 (FIG. 9B) for use in the stand 1 in a similar fashion as described above for the cartridge 7. Further, multiple cartridges 601 having end caps 613 may be connected to the cartridge loading station 401 (FIG. 15) as described above for the cartridge 7.

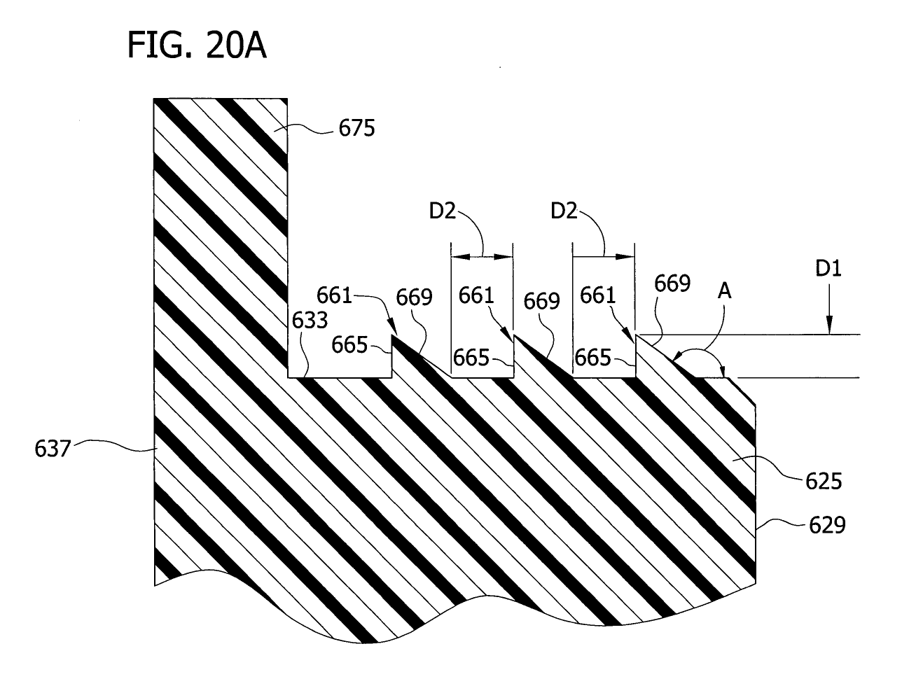

As shown in FIGS. 18 and 20, each end cap 613 of the cartridge 601 comprises a generally cylindric body 625 having an inner face 629 that contacts the frit 621, an external axial surface 633 that is received in the tube 605, and an outer face 637 defining an external end of the cartridge. A central flow passage, generally designated 641 passes through the end cap 613 between the outer face 637 and the inner face 629 to allow fluid flow through the end cap into or out of the tube 605. The central flow passage 641 is substantially similar to the central flow passage 277 of the first embodiment of the cartridge 7 in that the central flow passage is designed to allow a sealingly secure fluid connection between the end cap 613 and any suitable device (e.g., stand 1, coupler 329, or sample holder 423) having a male luer fitting. The central flow passage 641 opens to radial grooves 645 on the inner face 629 of the end cap 613 that facilitate a uniform flow distribution of solvent at the inlet end of the cartridge 601 and allow for collection of solvent and sample components at the outlet end of the cartridge.

The external axial surface 633 of the end cap 613 has three annular barbs, generally designated 661, extending from the axial surface of the body 625 for contact with the interior surface 609 of the tube 605. Each barb 661 (broadly, “a protrusion”) is sized so that the end cap 613 has an interference fit with the interior of the tube 605 to form a fluid- tight connection between the end cap and the tube. Each annular barb is formed as one piece with the end cap 613 and extends around the circumference of the external axial surface 633 of the body 625. However, one or more of the barbs 661 could be formed separately and attached to the body 625 without departing from the scope of the present invention.

As shown in FIG. 20A, each barb 661 has a first surface 665 extending substantially perpendicular to the external axial surface of the body and a second surface 669 that intersects the first surface to form the free edge margin of the barb. In one embodiment, the barbs 661 may project from the axial surface 633 of the body 625 by a distance D1 (FIG. 20A) of at least approximately 0.7 mm. In the illustrated embodiment, each barb 661 has a diameter measured at its free end margin that is approximately 3% larger than the diameter of the axial surface 633 of the end cap 613. The diameter of the barbs 661 could preferably range from about 1% to about 7% larger than the diameter of the axial surface 633 without departing from the scope of this invention. As shown in FIG. 20A, the inner most barb 661 and outer most barb are spaced from the middle barb by an equal distance D2, but it will be understood that the end caps 613 may have more or less than three barbs located at unequal spacings on the axial surface 633 of the end cap. In the illustrated embodiment, the second surface 669 of each barb 661 extends from the external axial surface 633 of the body 625 at an angle A. In the illustrated embodiment, the angle A is an obtuse angle of approximately 140 degrees, but the angle A may be otherwise sized and may preferably range from approximately 120 degrees to approximately 160 degrees. It will be understood that the barbs 661 could be otherwise sized and shaped without departing from the scope of this invention.

Each end cap 613 is sealingly held in the tube 605 by the close friction fit between the barbs 661 and the interior wall 609 of the tube. The barbs 661 are configured such that the cartridge 601 is free of any O-ring connection between the end caps 613 and the tube 605. As shown in FIG. 18, the end caps 613 are inserted into the tube 605 such that the barbs 661 deform slightly and press against the interior surface 609 of the tube such that the barbs created a fluid-tight seal between the end caps and the tube. The end caps 613 are retained in the tube 605 by the interference fit between the barbs 661 and the interior surface 609 of the tube. The angled second surface 669 of the barbs 661 allow the end cap to be more easily inserted into the tube 605 so that the barbs deform slightly and provide a holding force against the interior surface of the tube.

As shown in FIG. 18-21, each end cap 613 of the cartridge 601 has a generally cylindric flange 675 projecting radially outward from the body 625 of the end cap. The flange 675 of each end cap 613 is sized to overlay a respective axial end surface 615, 617 of the tube 605 when the end cap is inserted into the tube to define the closed ends of the cartridge 601. Each flange 675 has an external axial surface that is generally flush with the external axial surface of the tube 605 so that the cartridge 601 has a clean appearance upon insertion of the end caps 613 into the tube.

As shown in FIGS. 18 and 20, each end cap 613 has a connector portion, generally designated 681, at its outer face 637 axially aligned with the central flow passage 641 of the end cap. The connector portion 681 is substantially similar to the connector portion 305 (FIG. 2) described above for the cartridge 7 in that the connector portion facilitates alignment of the cartridge 601 in the stand 1. The connector portion 681 of each end cap 613 is sized to fit in a respective recess 131 in the guide plate 119 (FIG. 2) of the top and bottom platen 37, 39 of the stand 1 so that the cartridge 601 is in fluid connection with the stand. Further, the connector portion 681 facilitates connection of the cartridge 601 to the coupler 329 (FIG. 9) used for cartridge stacking and the sample holder 423 (FIG. 15) used for cartridge loading.

In the embodiment of FIGS. 18-21, the cartridge 601 is constructed from tube 605 having an inner diameter of approximately 40.5 mm with a wall thickness of about 6 mm. In another embodiment, the tube 605 may have an inner diameter of approximately 80 mm and a wall thickness of about 6 mm. The external axial surface 633 of the cylindric body 625 of the end cap 613 may have a diameter of approximately 40.3 mm for a tube having an inner diameter of 40.5 mm or a diameter of about 79.6 mm for a tube having an inner diameter of 80 mm. The flange 675 of the end cap 613 may project from the axial surface 633 of the cylindrical body 625 by approximately 6 mm. The connector portion 681 of the end cap 613 may have a diameter of approximately 25 mm and project axially outward from th flange by approximately 8 mm. The foregoing dimension are exemplary and do not limit the scope of the present invention.

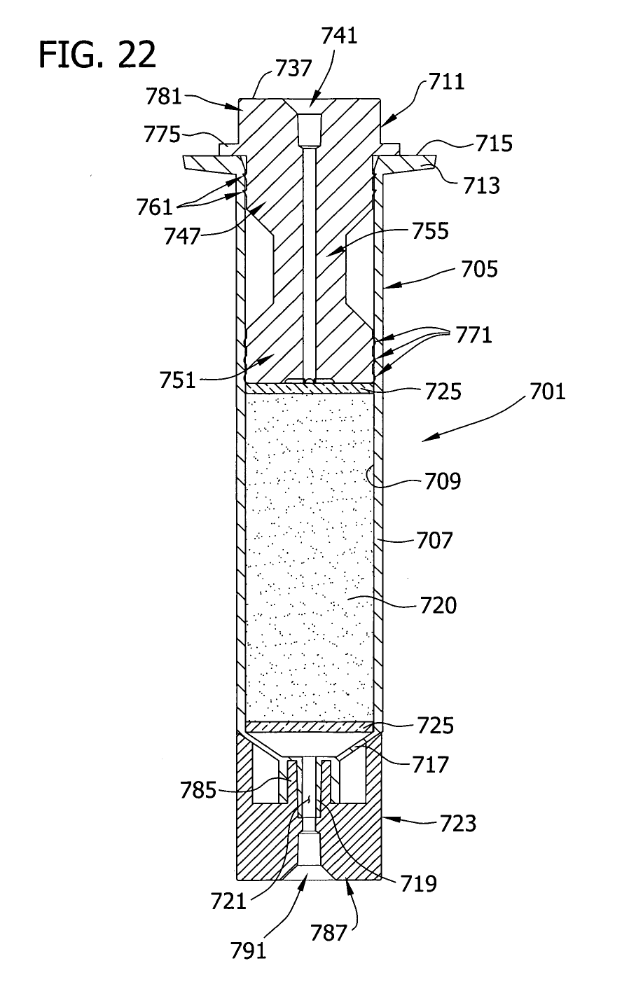

A third embodiment of the chromatography cartridge of the present invention, generally designated 701, is shown in FIGS. 22-25. This embodiment 701 is similar to the previous embodiments in that the cartridge may be used in the chromatography stand 1. In the illustrated embodiment, the cartridge 701 comprises a hollow body, generally indicated 705, having a cylindrical portion 707 with an inner surface 709 that receives an end cap, generally indicated 711, to define a closed end of the cartridge. The hollow body 705 includes an annular flange 713 having an axially facing end surface 715 defining an open end of the cylindrical portion 707 of the body. The hollow body 705 has a conical end portion 717 having a male luer fitting 719 defining an opening 721 of the hollow body. The cartridge 701 includes an adapter, generally indicated 723, in fluid connection with the fitting 719 for connecting the conical end portion 717 of the cartridge to the chromatography stand 1. As with the previous embodiments, the cartridge 701 is filled with chromatography media (e.g., silica gel) 720 contained between frits 725 in the hollow body 705. In the illustrated embodiment, the hollow body 705 is a conventional syringe body and the fitting 719 provides for a luer-lock/slip-luer connection. It is understood that the hollow body 705 may have other configurations without departing from the scope of this invention. Further, the syringe body 705 may be may be positioned in the chromatography stand 1 with the end cap 711 in contact with either the top or bottom platen 37, 39 of the stand 1 so that the fluid enters either the end cap 711 or the adapter 723 at the conical portion 717 of the syringe body.

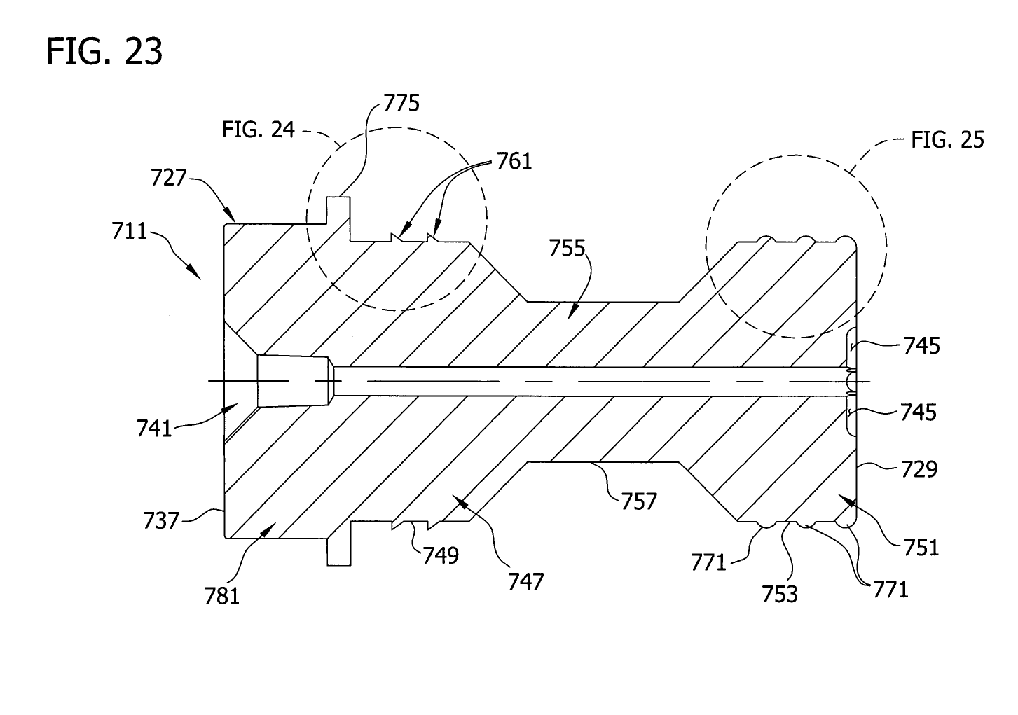

As shown in FIGS. 22 and 23, the end cap 711 of the cartridge 701 comprises a body, generally indicated 727, having an inner face 729 that contacts the frit 725 and an outer face 737 defining an external end of the cartridge. A central flow passage, generally designated 741 passes through the end cap 711 between the outer face 737 and the inner face 729 to allow fluid flow through the end cap into or out of the hollow body 705. The central flow passage 741 is substantially similar to the central flow passages 277 and 641 of the previous embodiments in that the central flow passage is designed to allow a sealingly secure fluid connection between the end cap 711 and any suitable device (e.g., stand 1, coupler 329, or sample holder 423) having a male luer fitting. The central flow passage 741 opens to multiple, radially extending grooves 745 on the inner face 729 of the end cap 711 that facilitate a uniform flow distribution of solvent at the inlet end of the cartridge 701 and allow for collection of solvent and sample components at the outlet end of the cartridge.

As shown in FIG. 23, the body 727 of the end cap 711 includes a first generally cylindrical portion, generally designated 747, that is received in the syringe body 705 and has a first axial surface 749 that contacts the inner surface 709 of the syringe body. The end cap body 727 has a second generally cylindrical portion, generally designated 751, that is received in the syringe body 705 and includes a second axial surface 753 of the end cap 711 that contacts the inner surface 709 of the body. In the illustrated embodiment, the body 727 is roughly hourglass-shaped and includes an intermediate axial portion generally designated 755, that has a reduced diameter and an axial surface 757 that is free from contact with the inner surface 709 of the syringe body 705. It is understood that the reduced diameter intermediate portion 755 of the body 727 could be eliminated such that an end cap (not shown) is cylindrical in shape, everywhere having an outer surface that substantially contacts the inner surface 709 of the syringe body 705 without departing from the scope of this invention.

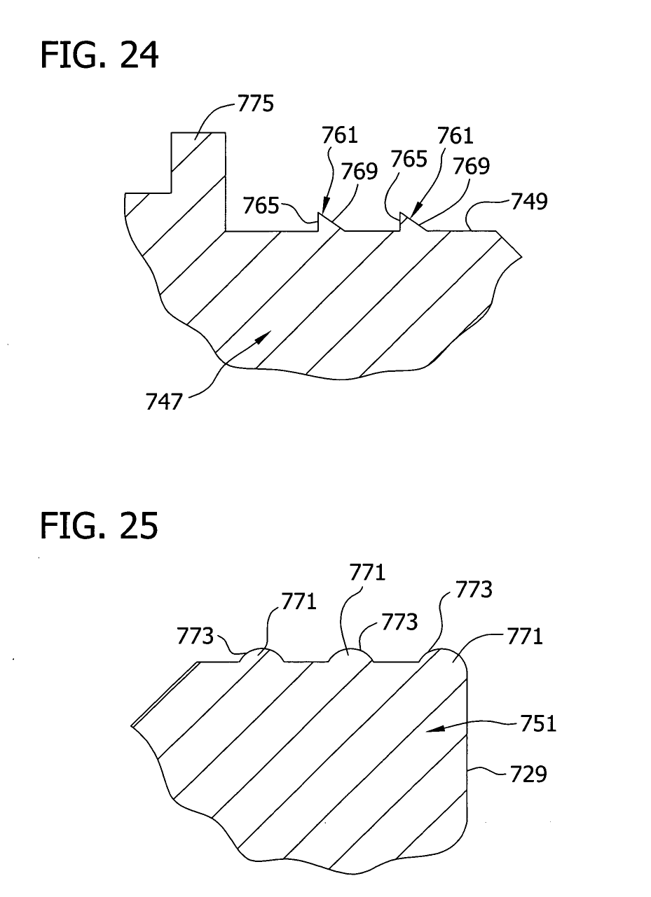

As shown in FIGS. 23 and 24, the first axial surface 749 of the end cap 711 has two annular barbs, generally designated 761, extending from the first axial surface of the body 727 for contact with the interior surface 709 of the syringe barrel 705. Each barb 761 is substantially similar to the barbs 661 disclosed in the previous embodiment. Each annular barb 761 is formed as one piece with the end cap 711 and extends around the circumference of the first external axial surface 749 of the body 727. However, one or more barbs (not shown) could be formed separately and attached to the body 727 without departing from the scope of the present invention. As with the previous embodiment, each barb 761 has a first surface 765 extending substantially perpendicular to the first axial surface 749 of the body 727 and a second surface 769 that intersects the first surface to form the free edge margin of the barb. It will be understood that the barbs 761 could be otherwise sized and shaped without departing from the scope of this invention.

As shown in FIGS. 23 and 25, the second axial surface 753 of the end cap 711 has three sealing protrusions 771 extending from the second axial surface of the body 727. Each sealing protrusion 771 is formed as one piece with the end cap 711 and extends around the circumference of the second external axial surface 753 of the body 727. However, one or more protrusions (not shown) could be formed separately and attached to the body 727 without departing from the scope of the present invention. In the illustrated embodiment, the sealing protrusions 771 each have a rounded external surface 773 but it is understood that the sealing protrusions could have surfaces with pointed edges without departing from the scope of this invention. The outer diameter of the sealing protrusions 771 is slightly larger than the inner diameter of the syringe body 705 so that the when the end cap 711 is inserted into the syringe body the protrusions deform slightly and press against the interior surface 709 of the syringe body such that the sealing protrusions create a fluid-tight seal between the end caps and the syringe body.

The end cap 711 is sealingly held in the syringe body 705 by the close friction fit between the barbs 761 and the interior wall 709 of the syringe body and the close friction fit between the sealing protrusions 771 and the interior wall of the syringe body. It is understood that the sealing protrusions 771 provide the primary fluid-tight seal between the end cap 711 and the syringe body 705 and the barbs 761 provide the primary mechanical holding force that retains the end cap in the syringe body. The end cap 711 is configured such that the cartridge 701 is free of any O-ring connection between the end caps and the tube 705. The end cap 711 is inserted into the syringe barrel 705 such that the barbs 761 and sealing protrusions 771 deform slightly and press against the interior surface 709 of the tube such that the barbs and sealing protrusions create a fluid-tight seal between the end caps and the tube.

As shown in FIG. 22 and 23, the end cap 711 of the cartridge 701 has an annular flange 775 projecting radially outward from the body 727 of the end cap. The flange 775 of the end cap 711 is sized to overlay an axial end surface 715 of the flange 713 on the syringe body 705 when the end cap is inserted into the tube to define the closed end of the cartridge 701. Each end cap 711 has a connector portion, generally designated 781, at its outer face 737 axially aligned with the central flow passage 741 of the end cap. The connector portion 781 is substantially similar to the connector portions 305 (FIG. 2) and 681 (FIG. 18) described above for the previous embodiments of the cartridge in that the connector portion facilitates alignment of the cartridge 701 in the stand 1. The connector portion 781 of each end cap 711 is sized to fit in a respective recess 131 in the guide plate 119 (FIG. 2) of the top and bottom platen 37, 39 of the stand 1 so that the cartridge 701 is in fluid connection with the stand. The annular flange 775 of the end cap 771 engages the guide plate 119 and also assists in locating the cartridge in the stand 1. Further, the connector portion 781 and flange 775 facilitates connection of the cartridge 701 to the coupler 329 (FIG. 9) used for cartridge stacking and the sample holder 423 (FIG. 15) used for cartridge loading.

As shown in FIG. 22, the adapter 723 of the cartridge 701 is generally cylindrical and has a fitting 785 adapted for mating with the male luer fitting 719 of the syringe body 705 and a connector portion, generally designated 787, that is substantially similar to the connector portion 781 on the end cap 711. In the illustrated embodiment, the fitting 785 is a female luer fitting that mates with the male luer fitting 719 on the syringe body 705 to provide a sealingly secure fluid connection between the syringe body and the adapter 723. The connector portion 787 is sized and shaped to fit a respective recess 131 in the guide plate 119 (FIG. 2) of the top and bottom platen 37, 39 of the stand so that the adapter 723 may be in fluid communication with the stand. The adapter 723 has a central flow passage 791 substantially similar to the central flow passage 741 of the end cap 711 in that the central flow passage is designed to allow a sealingly secure fluid connection between the adapter and any suitable device (e.g., stand 1, coupler 329, or sample holder 423) having a male luer fitting.

It will be understood that the construction of the connection portions 781, 787 of the end cap 711 and the adapter 723 allows the cartridge 701 to be installed in the stand 1 with either end on top. Also, two cartridges 701 may be connected together by the coupler 329 (FIG. 9), 371 (FIG. 9B) for use in the stand 1 in a similar fashion as described above for the cartridge 7. Further, multiple cartridges 701 having end caps 711 may be connected to the cartridge loading station 401 (FIG. 15) as described above for the cartridge 7.

In view of the above, it will be seen that the several objects of the invention are achieved and other advantageous results attained.

As various changes could be made in the above constructions without departing from the scope of the invention, it is intended that all matter contained in the above description or shown in the accompanying drawings shall be interpreted as illustrative and not in a limiting sense.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

1. A chromatography cartridge for use in a chromatography stand comprising:
a hollow body for containing chromatography media,
an end cap adapted to fit in an open end of the hollow body for closing the end of the hollow body, the end cap having an external axial surface at least partially received in the hollow body and an outer face,
at least one barb extending from the external axial surface of the end cap, the at least one barb being shaped and arranged to contact an interior surface of the hollow body,
at least one sealing protrusion extending from the external axial surface of the end cap, the at least one sealing protrusion being shaped and arranged for use in forming a fluid-tight connection between the end cap and the hollow body.

2. The chromatography cartridge set forth in claim 1 wherein the barb and sealing protrusion are formed as one piece with the end cap.

3. The chromatography cartridge set forth in claim 1 wherein the cartridge is free of any O-ring between the end cap and the hollow body.

4. The chromatography cartridge set forth in claim 1 wherein said at least one sealing protrusion is rounded and adapted to engage the interior surface of the hollow body around an interior diameter therof.

5. The chromatography cartridge set forth in claim 4 wherein said barb comprises a first generally planar surface extending from the external axial surface of the end cap and a second generally planar surface that intersects the first surface at a free edge margin of the barb.

6. The chromatography cartridge set forth in claim 5 wherein said first surface is substantially perpendicular to the external axial surface of the end cap and said second surface of the barb extends from the external axial surface of the end cap at an obtuse angle with respect to the external axial surface of the end cap, said obtuse angle ranging from approximately 120 degrees to approximately 160 degrees.

7. The chromatography cartridge set forth in claim 1 wherein said end cap comprises plural barbs in axially spaced relation thereon.

8. The chromatography cartridge set forth in claim 7 wherein said end cap comprises plural sealing protrusions in axially spaced relation thereon.

9. The chromatography cartridge set forth in claim 8 wherein the barbs are arranged in a first group disposed generally adjacent to the open end of the hollow body and the sealing protrusions are arranged in a second group disposed axially inward of the open end and the first group.

10. The chromatography cartridge set forth in claim 1 wherein said hollow body comprises a syringe body having a male luer fitting at one end thereof and the chromatography cartridge further comprising an adapter connected to the hollow body over the male luer fitting, the adapter having a connector portion adapted for plug-in connection with the chromatography stand to allow fluid communication between the stand and the interior of the hollow body.

11. The chromatography cartridge set forth in claim 1 wherein the end cap includes a connector portion adapted for plug-in connection with the chromatography stand to allow fluid communication with the interior of the hollow body.

12. The chromatography cartridge set forth in claim 1 in combination with chromatography media.

13. An end cap for defining the end of a chromatography cartridge having a hollow body containing chromatography media, the end cap comprising:
a body having an external axial surface adapted to be received in the hollow body;
a flange projecting radially outward from the body adapted to engage an end of the hollow body;
a connector portion at an end of the end cap for use in connecting the cartridge to a chromatography stand;
at least one barb projecting from the external axial surface of the body for contact with an interior surface of the hollow body; and
at least one sealing protrusion projecting from the external axial surface of the body for contact with the interior surface of the hollow body, the sealing protrusion being shaped and arranged to form a fluid-tight connection between the end cap and the hollow body.

14. The end cap set forth in claim 13 wherein said at least one barb and said at least one sealing protrusion are formed as one piece with the body.

15. The end cap set forth in claim 13 wherein the at least one barb and the at least one sealing protrusion are annular and extend around the circumference of the external axial surface.

16. The end cap set forth in claim 13 wherein said at least one barb comprises plural barbs in axially spaced relation on the cylindric body.

17. The end cap set forth in claim 13 wherein said at least one barb comprises a first generally planar surface extending from the external axial surface of the body and a second generally planar surface that intersects the first surface at a free edge margin of the barb, said second surface of the barb extending from the external axial surface of the cylindric body at an obtuse angle with respect to the external axial surface of the body.

18. The end cap set forth in claim 13 wherein said body comprises a first axial portion sized for contact with the inner surface of the hollow body, a second axial portion sized for contact with the inner surface of the hollow body and an intermediate portion between the first and second portion having a reduced diameter such that the axial surface of the intermediate portion is free from contact with the inner surface of the hollow body when the end cap is placed in the hollow body.

19. The end cap set forth in claim 13 wherein the end cap includes a connector portion adapted for plug-in connection with the chromatography stand to allow fluid communication with the interior of the hollow body.
